(19) United States
(12) Patent Application Publication
(10) Pub. No.: US 2026/0274877 A1
(43) Pub. Date: Sep. 17, 2026

(54) BODIPY COMPOUND, AND TEMPERATURE-SENSITIVE FLUORESCENT SENSOR OF CELL ORGANELLES COMPRISING SAME

(71) Applicants: INSTITUTE FOR BASIC SCIENCE, Daejeon (KR); POSTECH ACADEMY-INDUSTRY FOUNDATION, Pohang-si Gyeongsangbuk-do (KR); NATIONAL UNIVERSITY CORPORATION KANAZAWA UNIVERSITY, Kanazawa-shi, Ishikawa (JP)

(72) Inventors: Young-Tae CHANG, Daejeon (KR); Xiao LIU, Pohang-si Gyeongsangbuk-do (KR); Arai SATOSHI, Kanazawa-shi, Ishikawa (JP); Yamazaki TAKERU, Kanazawa-shi, Ishikawa (JP)

(21) Appl. No.: 18/868,706

(22) PCT Filed: May 23, 2023
(86) PCT No.: PCT/KR2023/006990

§ 371 Date: Nov. 22, 2024

Related U.S. Application Data
(60) Provisional application No. 63/344,861, filed on May 23, 2022.

(51) Int. Cl. C07F 9/6596; C07F 5/02; G01K 11/16; G01K 11/20; G01N 21/64

(52) U.S. Cl. CPC C07F 9/6596; C07F 5/022; G01K 11/16; G01K 11/20; G01N 21/6486

(57) ABSTRACT

The present invention relates to a BODIPY compound, and a temperature-sensitive fluorescent sensor of cell organelles comprising same. A BODIPY compound according to one aspect can quickly detect minute temperature changes with high sensitivity and accurately target various cell organelles and has no cytotoxicity. That is, the BODIPY compound according to one aspect can visualize the temperature for each cell organelle and is expected to be useful as a temperature-sensitive fluorescent sensor of cell organelles.

### TECHNICAL FIELD

The present disclosure relates to a BODIPY compound and a temperature-sensitive fluorescent sensor of cell organelles, including the same.

### BACKGROUND ART

Temperature in cells is closely related to cell processes such as proliferation, metabolism, differentiation, and proliferation of cells, and it is very important to map microscopic temperature of various cell organelles by each organelle for understanding various biological phenomena.

Accordingly, various types of thermometers to investigate temperature in cells have been developed, and among them, a fluorescent thermometer using a fluorescent material which shows changes in fluorescence signals such as fluorescence intensity, anisotropy, and lifetime depending on temperature is in the spotlight. The fluorescent thermometer has high sensitivity to temperature changes, may detect subtle temperature changes, and favorably, may be evenly distributed in all types of cells derived from various species.

In order to know the subtle temperature changes in different cell organelles, it is essential to develop a thermometer for each cell organelle, but the fluorescent thermometers which have been developed to date do not have cell organelle specificity or may be applied to one or two types of cell organelle such as endoplasmic reticulum (ER) or mitochondria, and when it is intended to impart specificity to various cell organelles, there are limitations such as decreased sensitivity or deteriorated cytotoxicity.

### DISCLOSURE

### Technical Problem

An object of the present invention is to provide a BODIPY compound having a novel structure, and a fluorescent sensor which includes the BODIPY compound and may detect temperature for each cell organelle.

Another object of the present invention is to provide a method for measuring temperature of cell organelles using the fluorescent sensor.

### Technical Solution

In one general aspect, a compound represented by the following Chemical Formula 1 is provided:

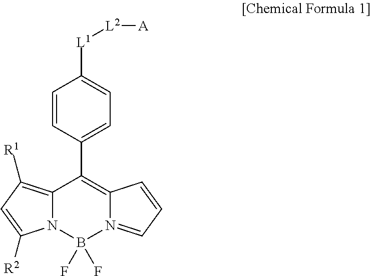

wherein
R¹ and R² are independently of each other (C1-C7)alkyl;
L¹ is —NR³C(═O)—, —C(═O)NR⁴—, or —NR⁵S(═O)₂—;
R³ to R⁵ are independently of one another hydrogen, (C1-C7)alkyl, or (C6-C12)aryl;
L² is a single bond, (C1-C30)alkylene, or (C1-C30)heteroalkylene;
—CH₂— of the alkylene and the heteroalkylene of L² may be replaced with one or two or more selected from —C(═O)— and —S(═O)₂—;
the alkylene and the heteroalkylene of L² may be further substituted by a hydroxyl group;
A is (C2-C30)alkyl, (C2-C30)alkenyl, (C6-C30)aryl, (C1-C7)alkyl(C6-C30)aryl, (C2-C30)heteroaryl, (C2-C30)heterocycloalkyl,

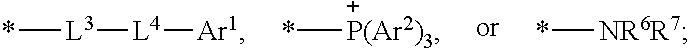

L³ and L⁴ are independently of each other (C2-C30)alkenylene, (C6-C30)arylene, or (C2-C30)heteroarylene;
Ar¹ is (C6-C30)aryl, (C1-C7)alkoxy(C6-C30)aryl, (C2-C30)heteroaryl, (C3-C30)cycloalkyl, or (C2-C30)heterocycloalkyl;
Ar² is (C6-C30)aryl or (C2-C30)heteroaryl;
R⁶ and R⁷ are independently of each other hydrogen, (C1-C20)alkyl, (C6-C20)aryl, or

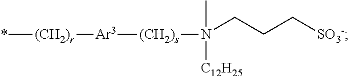

Ar³ is (C6-C30)arylene or (C2-C30)heteroarylene; and
r and s are independently of each other an integer of 1 to 5.

As an example, A may be (C2-C20)alkyl, (C2-C20)alkenyl, (C1-C7)alkyl(C6-C20)aryl, (C2-C20)heterocycloalkyl,

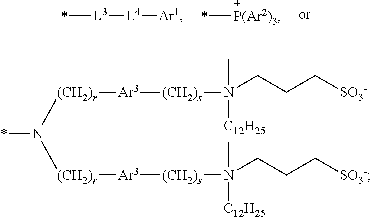

L³ may be (C6-C20)arylene or (C2-C20)heteroarylene; L⁴ may be (C2-C20)alkenylene or (C2-C20)heteroarylene; Ar¹ may be (C1-C7)alkoxy(C6-C20)aryl or (C2-C20)heterocycloalkyl; Ar² may be (C6-C20)aryl; Ar³ may be (C2-C20)heteroarylene; and r and s may be independently of each other an integer of 1 to 5.

The compound according to an embodiment may be represented by any one of the following Chemical Formula 2 to 7:

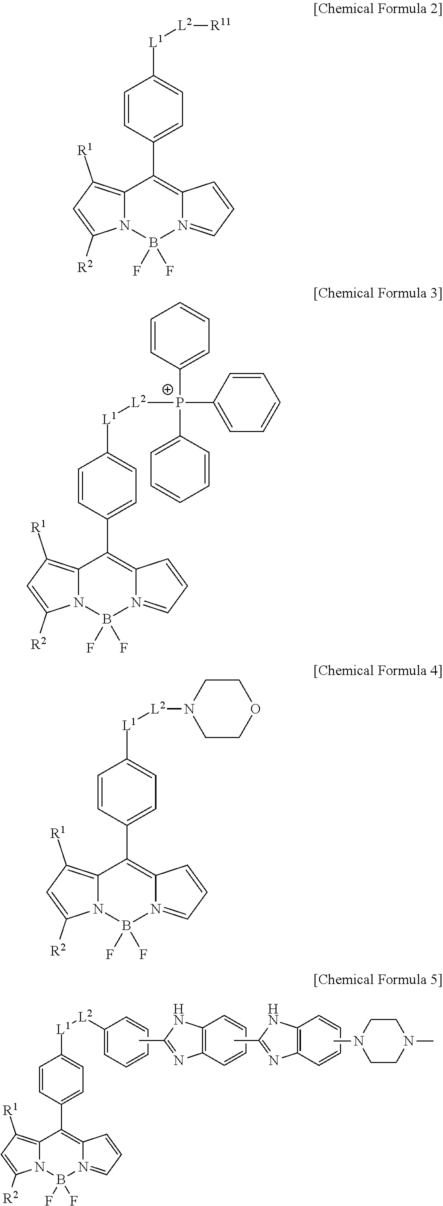

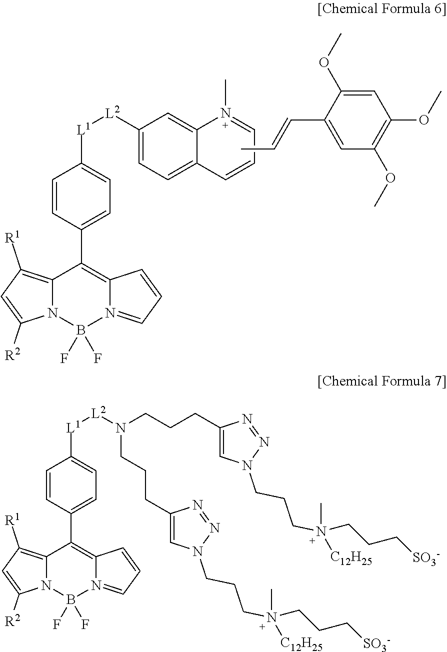

wherein
R¹ and R² are independently of each other (C1-C7)alkyl;
R¹¹ is (C2-C20)alkyl, (C2-C20)alkenyl, (C6-C20)aryl, or (C1-C7)alkyl(C6-C20)aryl;
L is —NHC(═O)—, —C(═O)NH—, or —NHS(═O)₂—;
L² is a single bond, (C1-C20)alkylene, or (C1-C20)heteroalkylene;
—CH₂— of the alkylene and the heteroalkylene of L² may be replaced with one or two or more selected from —C(═O)— and —S(═O)₂—; and
the alkylene and the heteroalkylene of L² may be further substituted by a hydroxyl group.

As an example, L² may be a single bond, (C1-C10)alkylene,

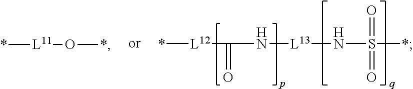

L¹¹ and L¹² may be independently of each other (C1-C10)alkylene; L¹³ may be a single bond, (C1-C10)alkylene, or *-L¹⁴-O—*; L¹⁴ may be (C1-C10)alkylene; the alkylene of L² and L¹¹ to L¹³ may be further substituted by a hydroxyl group; p and q may be independently of each other an integer of 0 or 1; and at least one of p and q may be 1.

The compound according to an embodiment may be represented by one of the following Chemical Formulae 11 to 18:

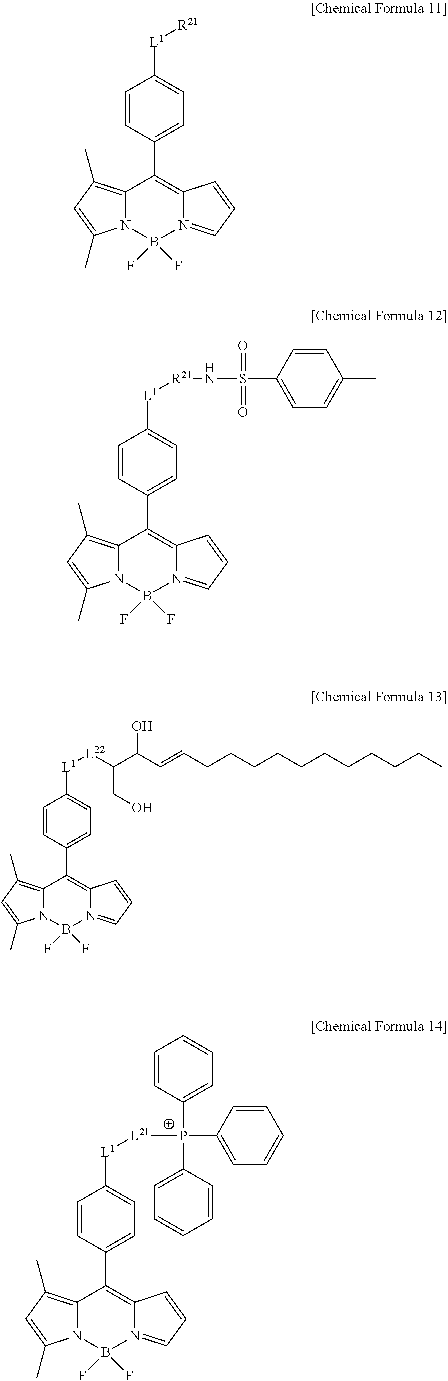

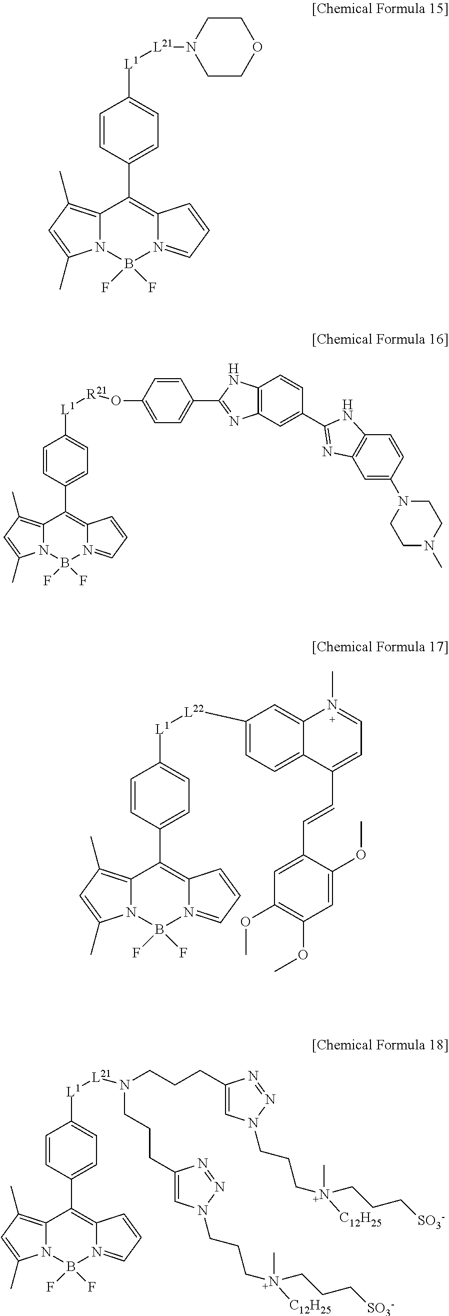

wherein
L¹ is —NHC(═O)—, —C(═O)NH—, or —NHS(═O)₂—;
R²¹ is (C2-C10)alkyl or

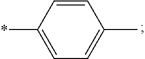 [SMILES: *c1ccc(C)cc1]

L²¹ is (C1-C4)alkylene or

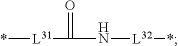

L²² is a single bond or

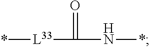

and
L³¹ to L³³ are independently of one another (C1-C4)alkylene.

The compound according to an embodiment may be selected from the following structures:

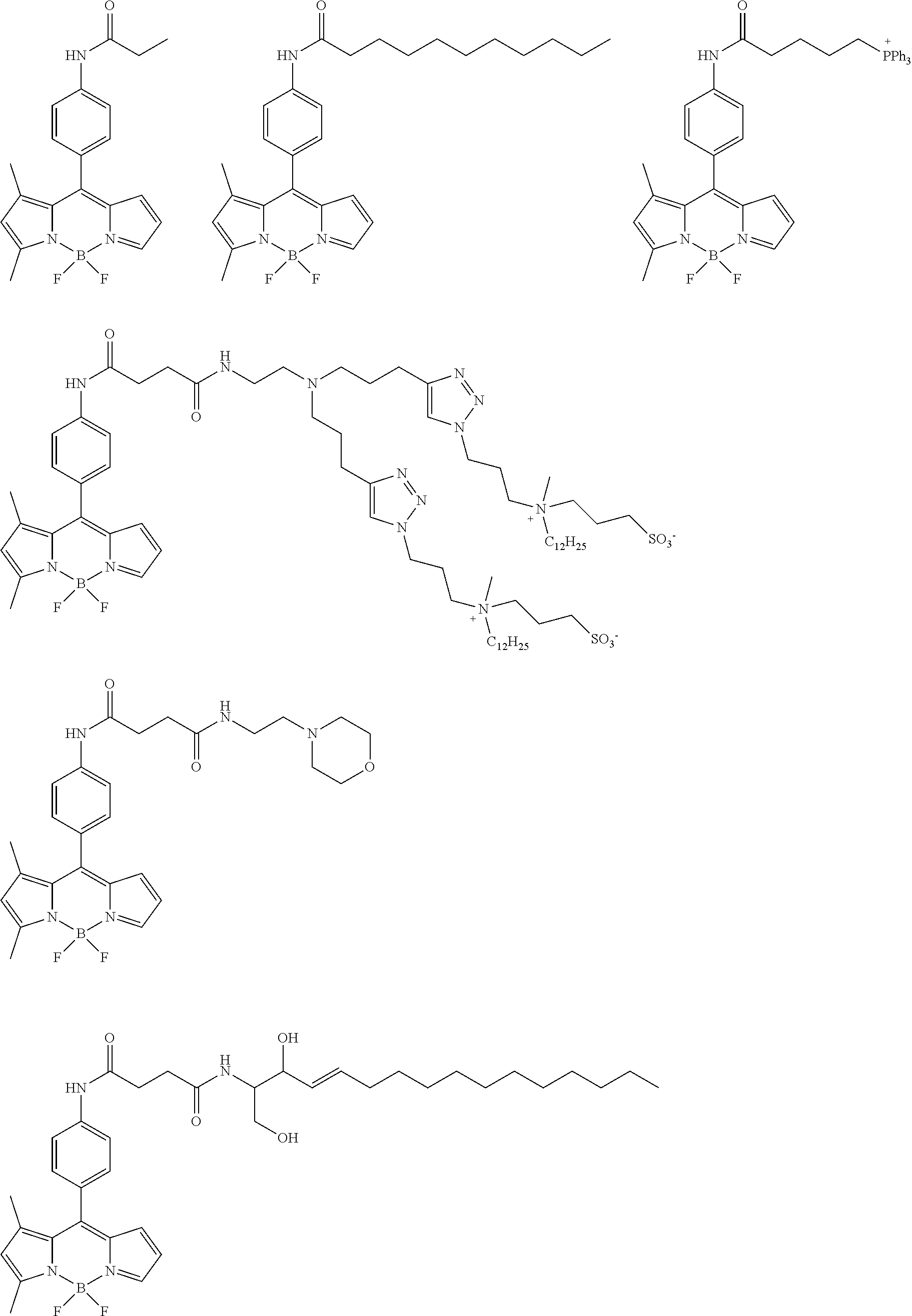

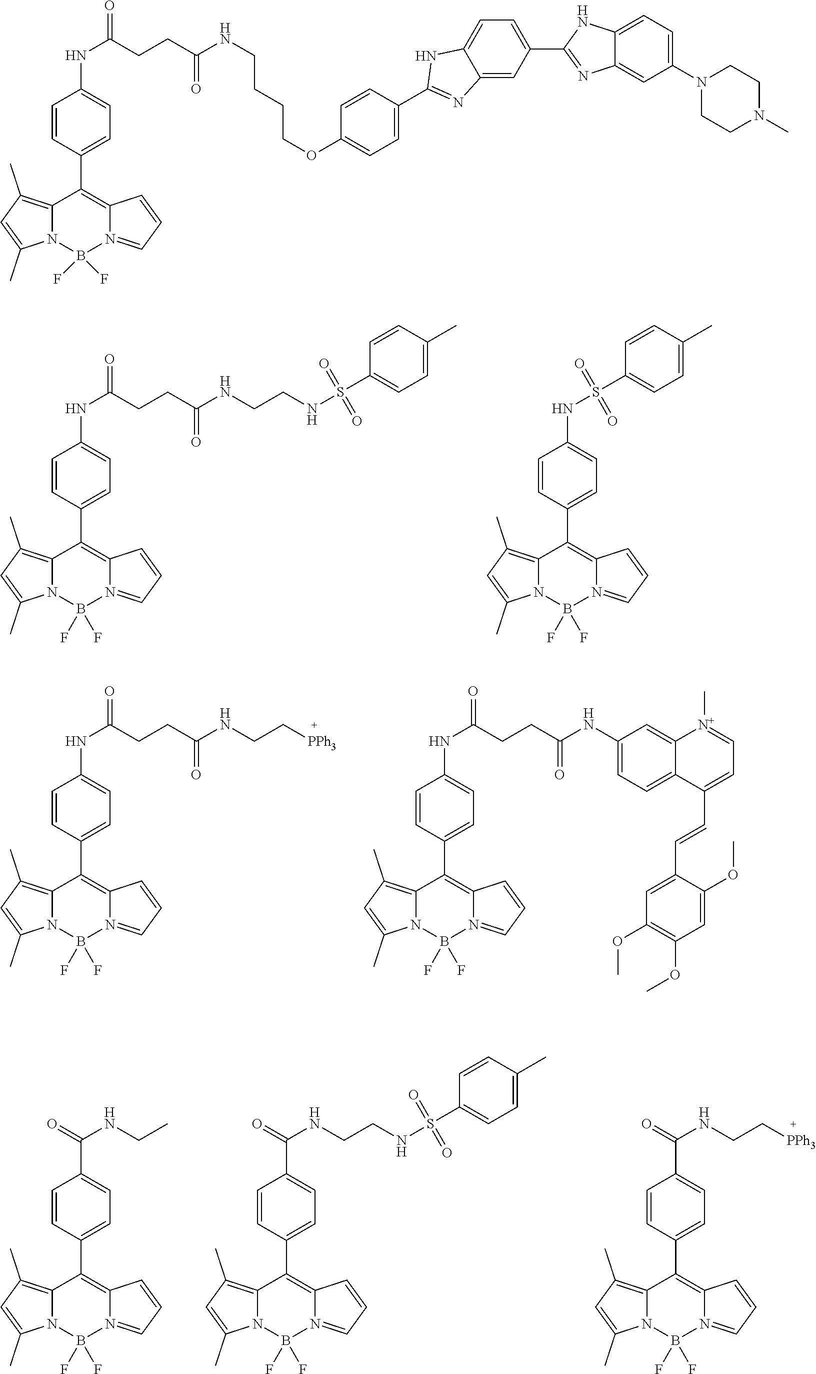

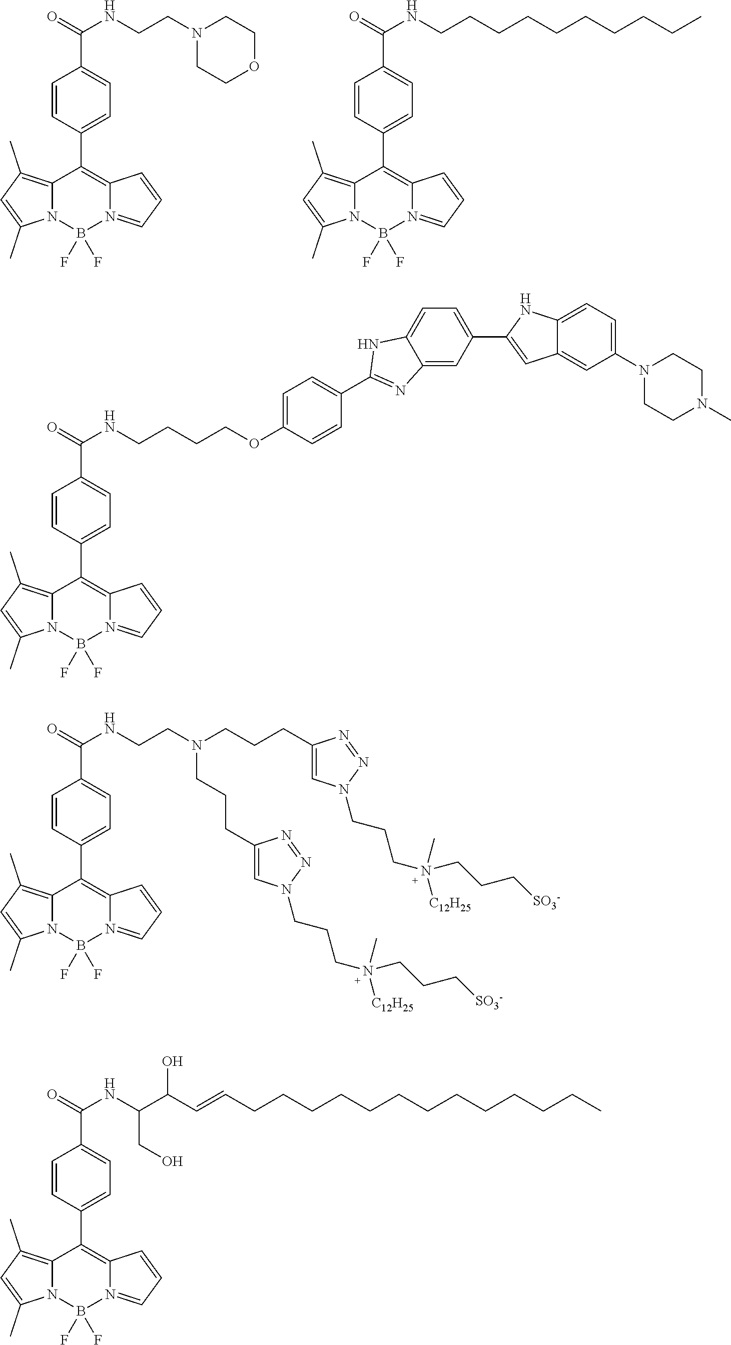

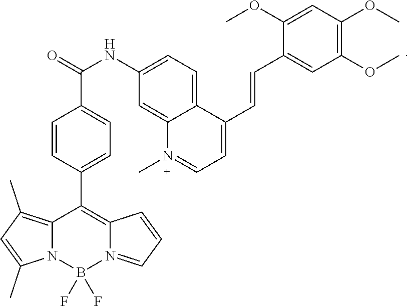

The compound according to an embodiment is characterized by targeting different cell organelles from each other.

The compound according to an embodiment may target cell organelles including endoplasmic reticulum, lipid droplets, Golgi apparatuses, mitochondria, lysosomes, nuclei, nucleoli, and plasma membranes.

In another general aspect, a temperature-sensitive fluorescent sensor of cell organelles includes a compound represented by the following Chemical Formula 1:

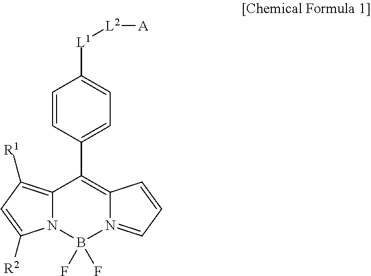

wherein
R₁, R₂, L₁, L₂, and A are as defined above.

The cell organelle may include endoplasmic reticulum, lipid droplets, Golgi apparatuses, mitochondria, lysosomes, nuclei, nucleoli, and plasma membranes.

In still another general aspect, a method for measuring temperature of cell organelles using the fluorescent sensor is provided.

The method for measuring temperature of cell organelles may include: bringing the fluorescent sensor into contact with cells to stain the cells; analyzing a fluorescence lifetime of the stained cells; and calculating the temperature of the cell organelles depending on the analyzed fluorescence lifetime.

### Advantageous Effects

The BODIPY compound according to an embodiment may rapidly detect subtle temperature changes with high sensitivity. In addition, the BODIPY compound may accurately target each cell organelle such as lipid droplets, Golgi apparatuses, lysosomes, nuclei, nucleoli, and plasma membranes as well as endoplasmic reticulum and mitochondria, and also has no cytotoxicity. That is, the BODIPY compound according to an embodiment may visualize subtle temperature changes for each cell organelle and is expected to be useful as a temperature-sensitive fluorescent sensor of cell organelles.

### DESCRIPTION OF DRAWINGS

FIG. 1 shows results of evaluating cell organelle-specificity of the BODIPY compounds prepared in Examples 1 to 7.

FIG. 2 is graphs showing fluorescence lifetimes depending on temperatures of the BODIPY compounds prepared in Examples 1 to 7.

FIG. 3 shows results of a cell viability test of the BODIPY compounds prepared in Examples 1 to 7.

### BEST MODE

In the present specification, unless otherwise defined, all technical terms and scientific terms have the same meanings as those commonly understood by a person skilled in the art to which the present invention pertains. The terms used herein are only for effectively describing a certain specific example and are not intended to limit the present invention.

The singular form used in the present specification may be intended to also include a plural form, unless otherwise indicated in the context.

In addition, the numerical range used in the present specification includes all values within the range including the lower limit and the upper limit, increments logically derived in a form and span of a defined range, all double limited values, and all possible combinations of the upper limit and the lower limit in the numerical range defined in different forms. Unless otherwise defined in the present specification, values which may be outside a numerical range due to experimental error or rounding off of a value are also included in the defined numerical range.

The term “comprise” of the present specification is an open-ended description having a meaning equivalent to the term such as “is/are provided”, “contain” “have”, or “is/are have”, or “is/are characterized”, and does not exclude elements, materials or processes which are not further listed.

The term “heteroalkylene” of the present specification refers to a radical having two bonding sites derived from heteroalkyl, and the meaning of “hetero” is carbon being substituted by one or more heteroatoms selected from B, O, N, P, S, and Si atoms.

The term “alkylaryl” of the present specification refers to an aryl radical substituted by at least one alkyl, and as an example, includes tolyl, mesityl, and the like, but is not limited thereto.

The term “alkoxyaryl” of the present invention refers to an aryl radical substituted by at least one alkoxy.

An embodiment provides a BODIPY compound which may visualize subtle temperature changes for each cell organelle, and the BODIPY compound may be represented by the following Chemical Formula 1:

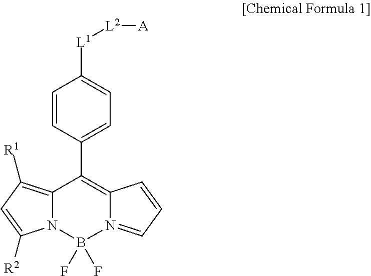

wherein
R¹ and R² are independently of each other (C1-C7)alkyl;
L¹ is —NR³C(═O)—, —C(═O)NR⁴—, or —NR⁵S(═O)₂—;
R³ to R⁵ are independently of one another hydrogen, (C1-C7)alkyl, or (C6-C12)aryl;
L² is a single bond, (C1-C30)alkylene, or (C1-C30)heteroalkylene;
—CH₂— of the alkylene and the heteroalkylene of L² may be replaced with one or two or more selected from —C(═O)— and —S(═O)₂—;
the alkylene and the heteroalkylene of L² may be further substituted by a hydroxyl group;
A is (C2-C30)alkyl, (C2-C30)alkenyl, (C6-C30)aryl, (C1-C7)alkyl(C6-C30)aryl, (C2-C30)heteroaryl, (C2-C30)heterocycloalkyl,

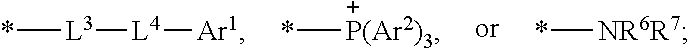

L³ and L⁴ are independently of each other (C2-C30)alkenylene, (C6-C30)arylene, or (C2-C30)heteroarylene;
Ar¹ is (C6-C30)aryl, (C1-C7)alkoxy(C6-C30)aryl, (C2-C30)heteroaryl, (C3-C30)cycloalkyl, or (C2-C30)heterocycloalkyl;
Ar² is (C6-C30)aryl or (C2-C30)heteroaryl;
R⁶ and R⁷ are independently of each other hydrogen, (C1-C20)alkyl, (C6-C20) aryl, or

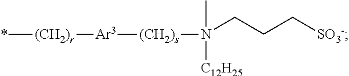

Ar³ is (C6-C30)arylene or (C2-C30)heteroarylene; and
r and s are independently of each other an integer of 1 to 5.

As an example, R¹ and R² may be independently of each other (C1-C5)alkyl, (C1-C3)alkyl, (C1-C2)alkyl, or —CH₃, and R¹ and R² may be identical to each other.

As an example, L² may be a single bond, (C1-C20)alkylene, or (C1-C20)heteroalkylene; —CH₂— of the alkylene and the heteroalkylene of L² may be replaced with one or two or more selected from —C(═O)— and —S(═O)₂—; and the alkylene and the heteroalkylene of L² may be further substituted by a hydroxyl group.

Since the compound according to an embodiment has structural characteristics as described above, for example, has a BODIPY mother nucleus structure in which an alkyl group (R¹ and R²) is asymmetrically substituted, and a phenylene group which is directly connected to the BODIPY mother nucleus structure, it may have excellent sensitivity to temperature. As an example, when it has a BODIPY mother nucleus having a symmetric structure or does not include a phenylene linking group, a fluorescence lifetime change depending on temperature is not significant, and thus, it may be difficult to detect temperature. In addition, the BODIPY compound according to an embodiment may accurately target each cell organelle such as endoplasmic reticulum, mitochondria, lipid droplets, Golgi apparatuses, lysosomes, nuclei, nucleoli, and plasma membranes according to the structure of the substituent A of Chemical Formula 1.

As an example, A may be (C2-C20)alkyl, (C2-C20)alkenyl, (C1-C7)alkyl(C6-C20)aryl, (C2-C20)heterocycloalkyl,

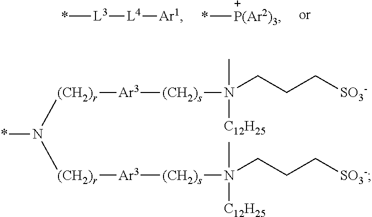

L³ may be (C6-C20)arylene or (C2-C20)heteroarylene; L⁴ may be (C2-C20)alkenylene or (C2-C20)heteroarylene; Ar¹ may be (C1-C7)alkoxy(C6-C20)aryl or (C2-C20)heterocycloalkyl; Ar² may be (C6-C20)aryl; Ar³ may be (C2-C20)heteroarylene; and r and s may be independently of each other an integer of 1 to 5.

As an example, L³ may be (C6-C12)arylene, phenylene, or (C2-C12)heteroarylene; L⁴ may be (C2-C10)alkenylene, (C2-C7)alkenylene, (C2-C5)alkenylene, ethenylene, or (C2-C20)heteroarylene; Ar¹ may be (C1-C3)alkoxy(C6-C12)aryl or (C2-C12)heterocycloalkyl; Ar² may be (C6-C12)aryl or phenyl; and Ar³ may be (C2-C12)heteroarylene or (C2-C6)heteroarylene.

As an example, the BODIPY compound according to an embodiment may be represented by any one of the following Chemical Formulae 2 to 7:

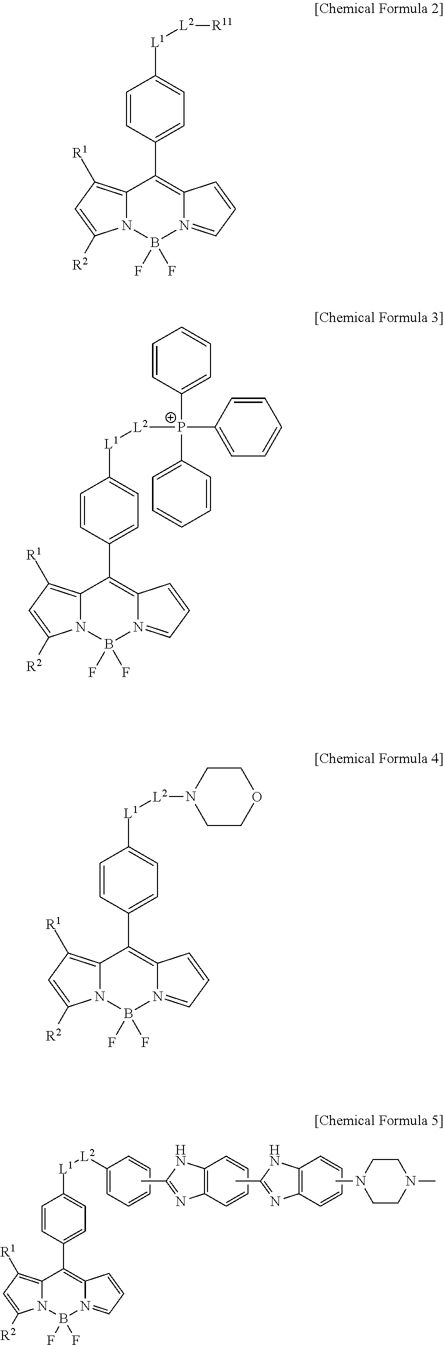

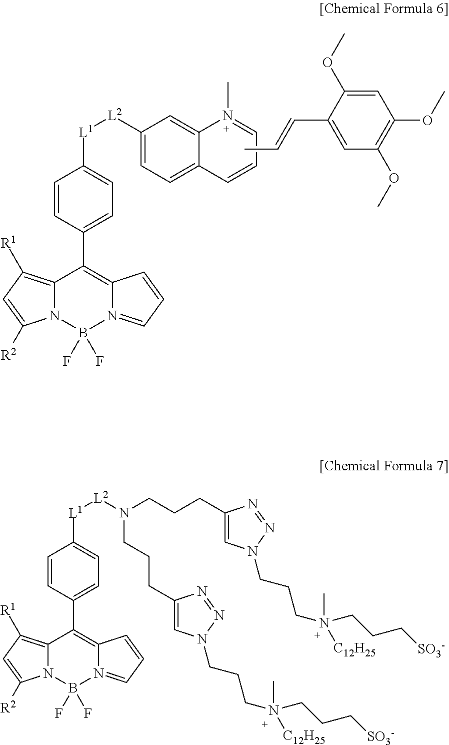

wherein
R¹ and R² are independently of each other (C1-C7)alkyl;
R¹¹ is (C2-C20)alkyl, (C2-C20)alkenyl, (C6-C20)aryl, or (C1-C7)alkyl(C6-C20)aryl;
L¹ is —NHC(═O)—, —C(═O)NH—, or —NHS(═O)₂—;
L² is a single bond, (C1-C20)alkylene, or (C1-C20)heteroalkylene;
—CH₂— of the alkylene and the heteroalkylene of L² may be replaced with one or two or more selected from —C(═O)— and —S(═O)₂—; and
the alkylene and the heteroalkylene of L² may be further substituted by a hydroxyl group.

As an example, R¹ and R² may be independently of each other (C1-C5)alkyl, (C1-C3)alkyl, (C1-C2)alkyl, or —CH₃, and R¹ and R² may be identical to each other.

As an example, R¹¹ may be (C2-C10)alkyl, (C2-C15)alkenyl, or (C1-C3)alkyl(C6-C12)aryl.

As an example, L² may be a single bond, (C1-C10)alkylene,

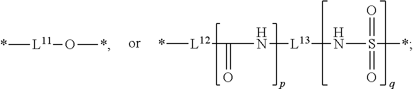

L¹¹ and L¹² may be independently of each other (C1-C10)alkylene; L¹³ may be a single bond, (C1-C10)alkylene, or *-L¹⁴-O—*; L¹⁴ may be (C1-C10)alkylene; the alkylene of L² and L¹¹ to L¹³ may be further substituted by a hydroxyl group; p and q may be independently of each other an integer of 0 or 1; and at least one of p and q may be 1.

As an example, L² may be a single bond, (C1-C10)alkylene, (C1-C7)alkylene, (C1-C4)alkylene,

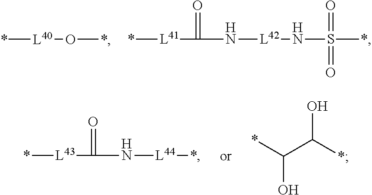

L⁴⁰ to L⁴³ may be independently of one another (C1-C10)alkylene, (C1-C7)alkylene, or (C1-C4)alkylene; L⁴⁴ may be (C1-C10)alkylene, (C1-C7)alkylene, (C1-C4)alkylene,

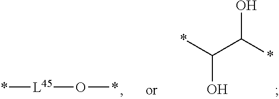

### L⁴⁵ may be (C1-C10)alkylene, (C1-C7)alkylene, or (C1-C4)alkylene.

The BODIPY compound represented by Chemical Formulae 2 to 7 may be characterized by targeting different cell organelles, and specifically, the BODIPY compound represented by Chemical Formula 2 may target endoplasmic reticulum (ER), lipid droplets (LD), or Golgi apparatuses (Golgi) according to R¹¹, the BODIPY compound represented by Chemical Formula 3 may target mitochondria (Mito), the BODIPY compound represented by Chemical Formula 4 may target lysosomes (Lyso), the compound represented by Chemical Formula 5 may target nuclei (Nuc), the compound represented by Chemical Formula 6 may target nucleoli, and the compound represented by Chemical Formula 7 may target plasma membranes (PM), accurately.

Specifically, the BODIPY compound represented by Chemical Formula 2 may target Golgi apparatuses when R¹¹ is (C2-C20)alkenyl, may target endoplasmic reticulum or lipid droplets when R¹¹ is (C2-C20)alkyl, and may target endoplasmic reticulum when R¹¹ is (C6-C20)aryl or (C1-C7)alkyl(C6-C20)aryl.

Specifically, when R¹¹ is alkyl, the BODIPY compound wherein R¹¹ is (C2-C4)alkyl may target endoplasmic reticulum, and the BODIPY compound wherein R¹¹ is (C5-C20)alkyl may target lipid droplets.

As an example, the BODIPY compound according to an embodiment may be represented by one of the following Chemical Formulae 11 to 18:

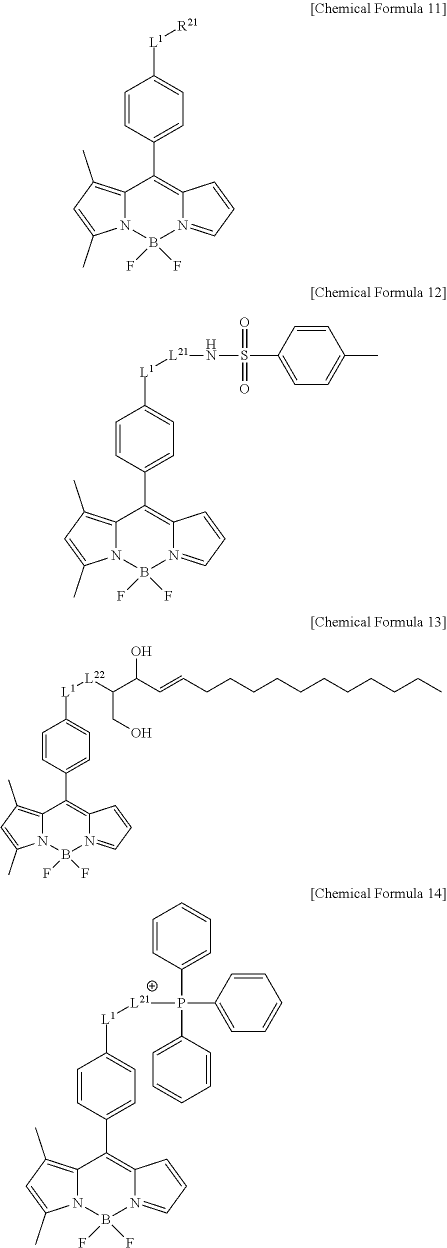

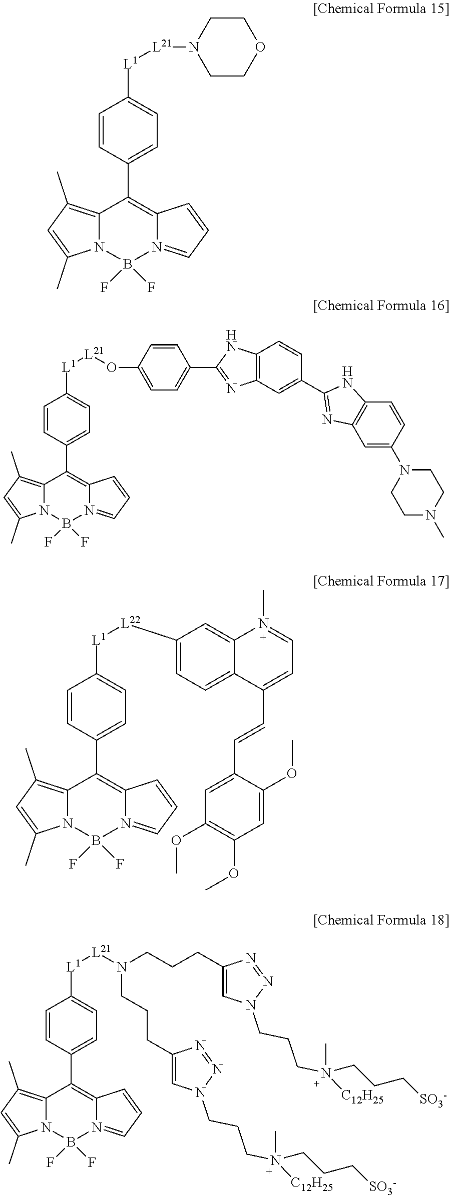

wherein
L¹ is —NHC(═O)—, —C(═O)NH—, or —NHS(═O)₂—;
R²¹ is (C2-C10)alkyl or

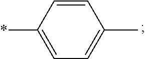 [SMILES: *c1ccc(C)cc1]

L²¹ is (C1-C4)alkylene or

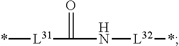

L²² is a single bond or

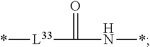

and
L³¹ to L³³ are independently of one another (C1-C4)alkylene.

The BODIPY compound represented by Chemical Formulae 11 to 18 according to an embodiment may be characterized by targeting different cell organelles from each other, and specifically, the BODIPY compound represented by Chemical Formula 11 may target endoplasmic reticulum or lipid droplets according to R²¹, the BODIPY compound represented by Chemical Formula 12 may target endoplasmic reticulum, the BODIPY compound represented by Chemical Formula 13 may target Golgi apparatuses, the BODIPY compound represented by Chemical Formula 14 may target mitochondria, the BODIPY compound represented by Chemical Formula 15 may target lysosomes, the BODIPY compound represented by Chemical Formula 16 may target nuclei, the BODIPY compound represented by Chemical Formula 17 may target nucleoli, and the BODIPY compound represented by Chemical Formula 18 may target plasma membranes, accurately.

Specifically, the BODIPY compound represented by Chemical Formula 11 may target endoplasmic reticulum when R²¹ is (C2-C4)alkyl or

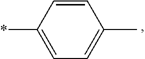 [SMILES: *c1ccc(C)cc1]

and may target lipid droplets when R²¹ is (C5-C20)alkyl.

The BODIPY compound according to an embodiment may be selected from the following structures, but is not limited thereto:

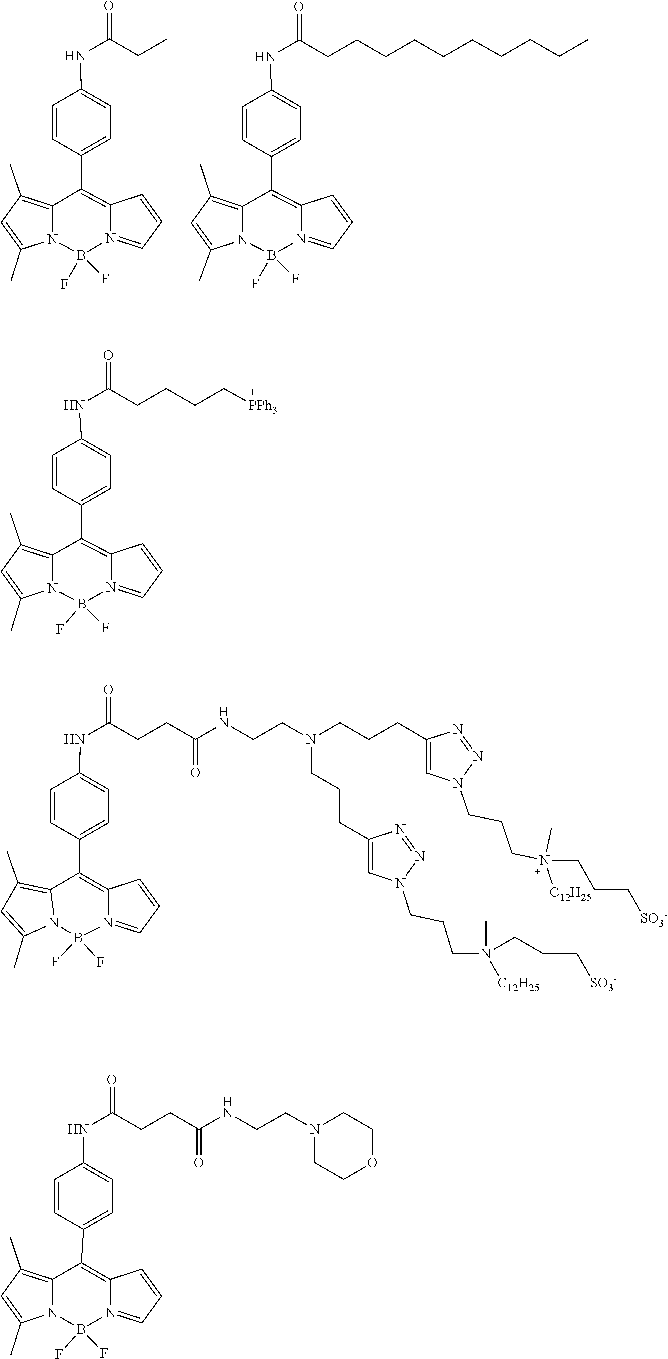

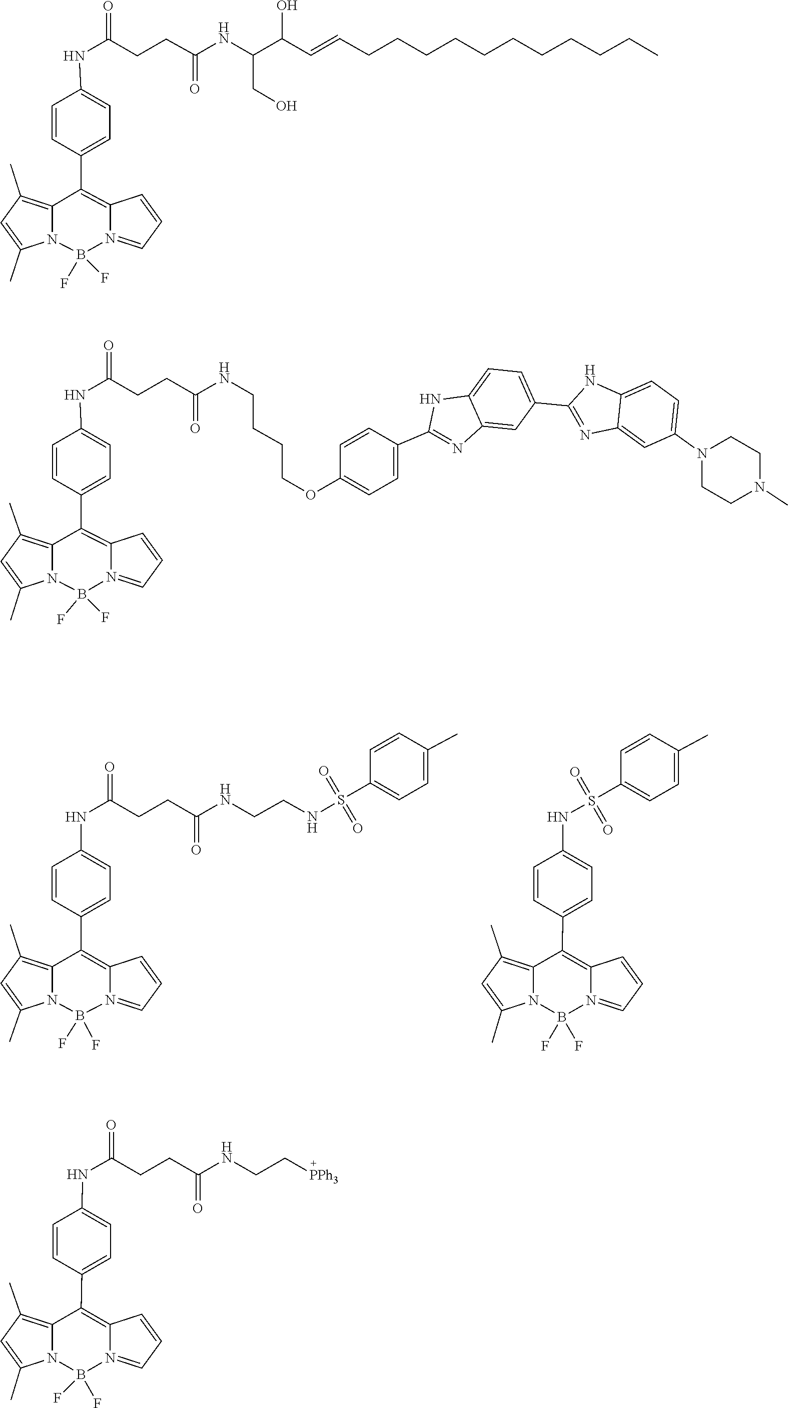

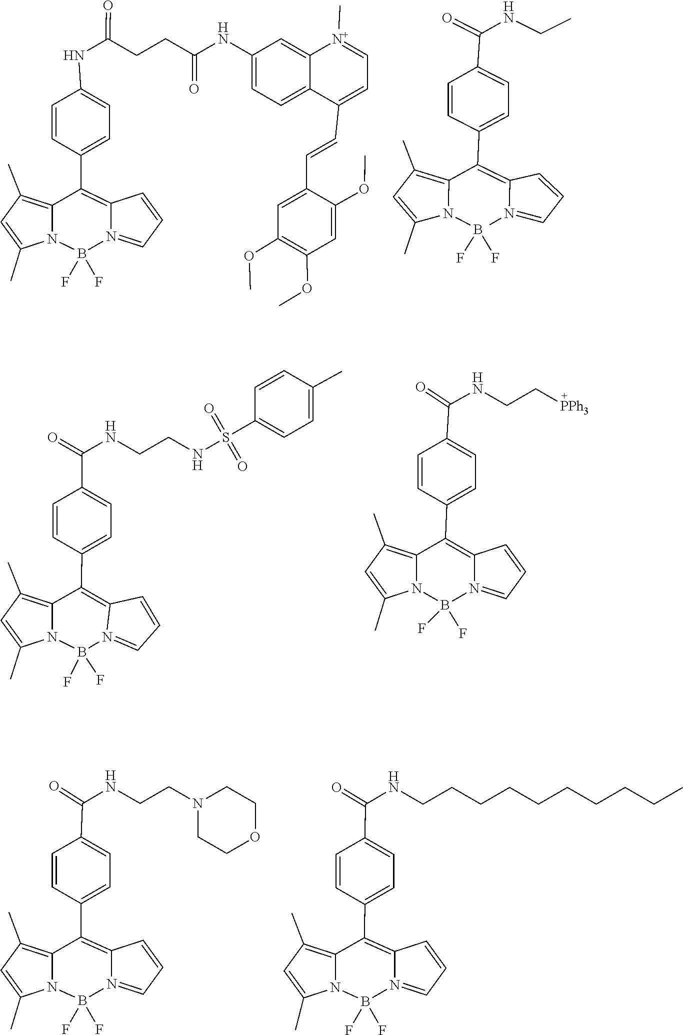

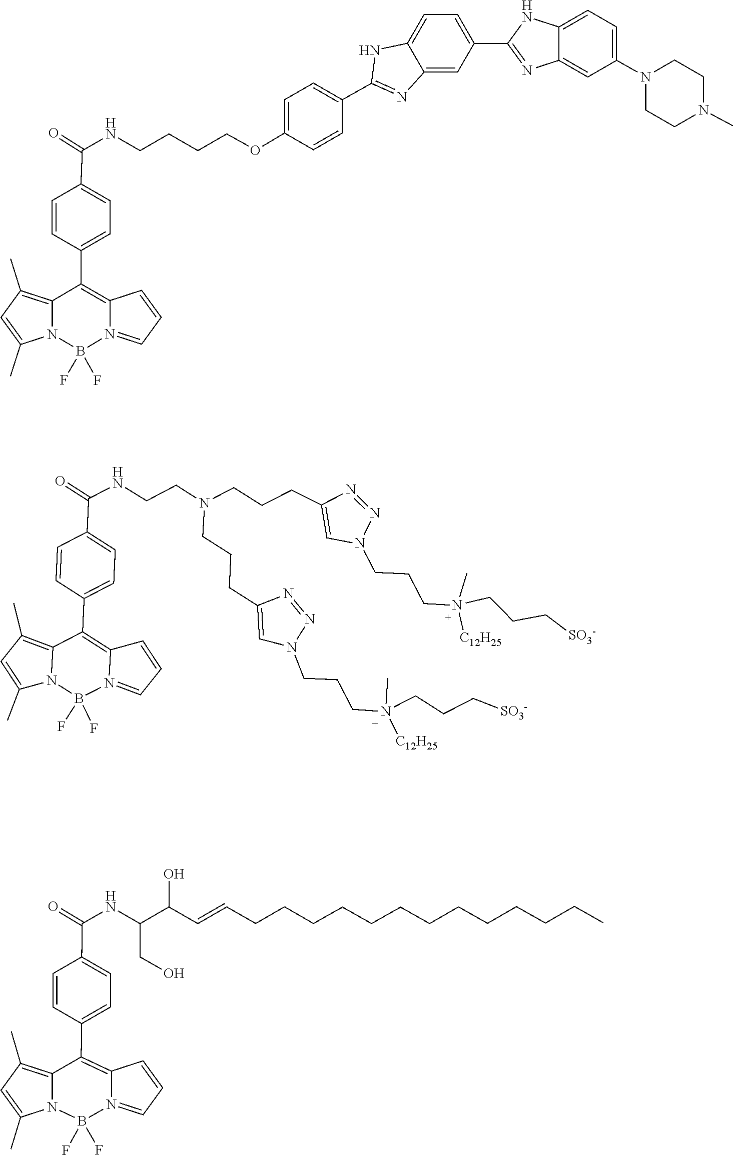

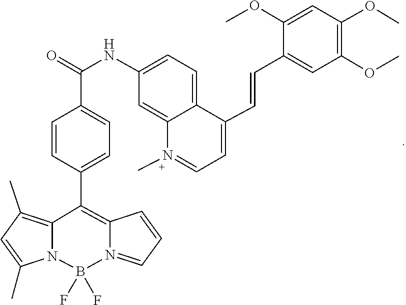

In addition, an embodiment provides a temperature-sensitive fluorescent sensor of cell organelles, including a compound represented by the following Chemical Formula 1:

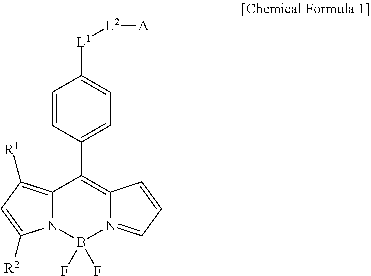

wherein
R₁, R₂, L₁, L₂, and A are as defined above for Chemical Formula 1.

The compound according to an embodiment shows an aspect of a decreased fluorescence lifetime with increasing temperature, and may be used as a fluorescent sensor which may shows a change in fluorescence lifetime even with a subtle temperature change to rapidly detect temperature changes with high sensitivity. In addition, the compound according to an embodiment may accurately target different cell organelles from each other according to the structure of the substituent A, and the cell organelle may include endoplasmic reticulum, lipid droplets, Golgi apparatuses, mitochondria, lysosomes, nuclei, nucleoli, and plasma membranes. That is, the compound according to an embodiment may visualize subtle temperature changes for each cell organelle and may be used as a temperature-sensitive fluorescent sensor of cell organelles. In addition, the compound according to an embodiment may detect temperature changes in two or more organelles at a time by treating cells with two or more BODIPY compounds having different structures from each other.

In addition, an embodiment provides a method for measuring temperature of cell organelles using the fluorescent sensor.

The method may include: bringing the fluorescent sensor into contact with cells to stain the cells; analyzing a fluorescence lifetime of the stained cells; and calculating the temperature of the cell organelles according to the analyzed fluorescence lifetime.

Specifically, the temperature of the organelle may be calculated from a calibration curve of fluorescence lifetime of the fluorescent sensor depending on temperature, and the calibration curve may be calculated by measuring fluorescence lifetime of stained cells at a standard temperature by a fluorescent sensor and measuring fluorescence lifetime depending on temperature changing from the standard temperature. Herein, the standard temperature refers to a temperature at which cells maintain homeostasis or an optimal temperature at which cells are maintained in a state appropriate for survival, and for example, the standard temperature of a human body may be 36.5° C.

Hereinafter, the exemplary embodiments described above will be described in detail through the following examples. However, the following examples are only for description, and do not limit the right scope.

### Example 1

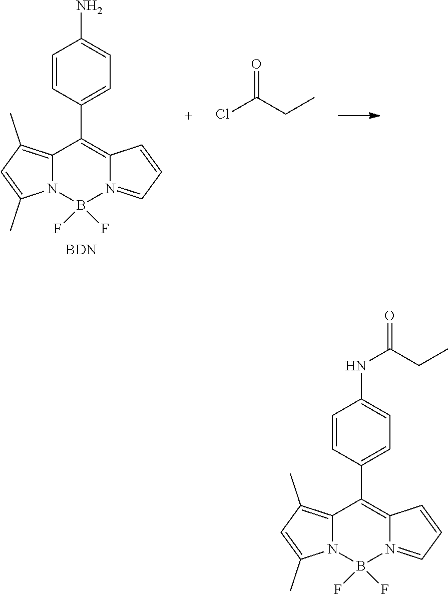

A BDN compound was prepared according to the method described in Angew. Chem. Int. Ed. 2013, 52, 8557-8560. The BDN compound (48.2 μmol) was dissolved in 5 mL of dichloromethane (DCM), the solution was cooled to 0° C., and propionyl chloride (144.6 μmol) and triethylamine (289.2 μmol) were added. The reaction was carried out at 0° C. for 10 minutes and at room temperature for 1 hour, concentration under vacuum was carried out, and HPLC purification was performed to obtain the compound of Example 1 (BODIPY compound 1).

### Example 2

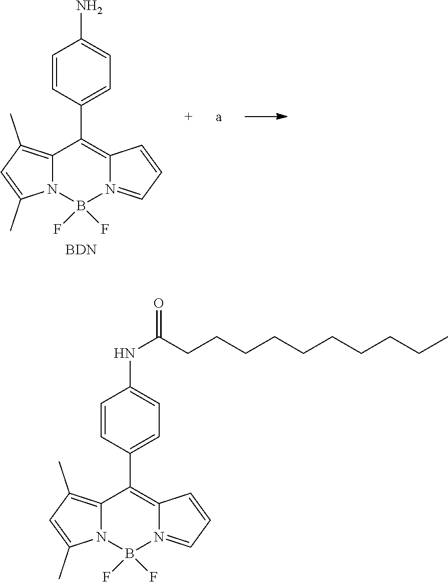

### (a): Undecanoyl Chloride

The BDN compound (48.2 μmol) was dissolved in 5 mL of dichloromethane (DCM), the solution was cooled to 0° C., and undecanoyl chloride (144.6 μmol) and triethylamine (289.2 μmol) were added. The reaction was carried out at 0° C. for 10 minutes and at room temperature for 1 hour, concentration under vacuum was carried out, and HPLC purification was performed to obtain the compound of Example 2 (BODIPY compound 2) (21.1 mg, 91.3%).

¹H NMR (850 MHz, Chloroform-d) δ 7.68 (d, J=7.7 Hz, 3H), 7.48 (s, 1H), 7.31 (s, 2H), 6.44 (d, J=2.9 Hz, 1H), 6.38 (s, 1H), 6.15 (s, 1H), 2.64 (s, 3H), 2.41 (t, J=7.6 Hz, 2H), 1.77 (p, J=7.5 Hz, 2H), 1.61 (s, 3H), 1.41 (p, J=7.2 Hz, 2H), 1.38-1.34 (m, 2H), 1.31 (dd, J=18.3, 11.6 Hz, 10H), 0.90 (t, J=7.1 Hz, 3H).

¹³C NMR (214 MHz, Chloroform-d) δ 171.74, 161.94, 146.91, 143.01, 139.36, 138.56, 134.75, 133.60, 129.68, 129.31, 127.00, 123.26, 119.20, 116.08, 37.88, 31.89, 29.58, 29.50, 29.40, 29.31, 25.56, 22.68, 15.34, 15.16, 14.12.

LC-MS m/z, calculated for [M+H]⁺: 480.3. Found: 480.2.

### Example 3

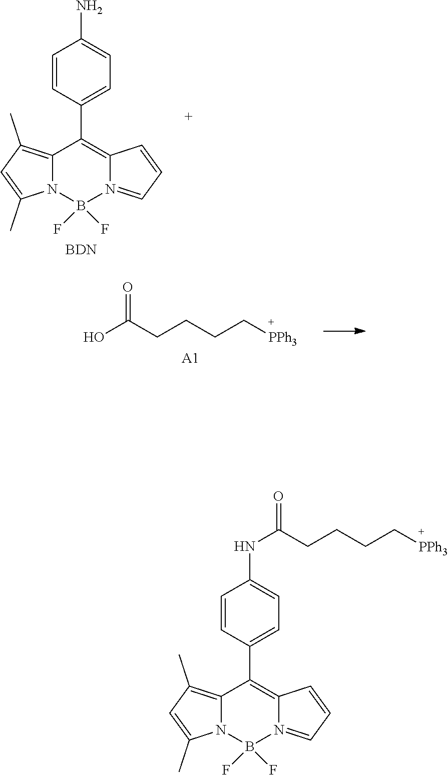

Compound A1 was prepared according to the method described in J. Am. Chem. Soc. 2000, 122, 10027-10032. A BDN compound (14.3 mg, 45.9 μmol) was dissolved in 5 mL of dimethylformamide (DMF), and a solution of 1-[bis(dimethylamino)methylene]-1H-1,2,3-triazolo[4,5-b]pyridinium 3-oxide hexafluorophosphate (HATU) (12.8 mg, 33.7 μmol) and diethylisopropylamine (11.72 μl, 67.3 μmol) dissolved in 1 mL of DMF was added. The reaction was carried out at room temperature for 12 hours, concentration under vacuum was carried out, and HPLC purification was performed to obtain the compound of Example 3 (BODIPY compound 3) (16.9 mg, 47.8%).

¹H NMR (850 MHz, Methanol-d4) δ 7.91-7.88 (m, 3H), 7.85-7.81 (m, 6H), 7.77 (td, J=7.9, 3.5 Hz, 6H), 7.73 (d, J=8.4 Hz, 2H), 7.63 (s, 1H), 7.36 (d, J=8.5 Hz, 2H), 6.44 (d, J=3.6 Hz, 1H), 6.42 (dd, J=3.8, 2.0 Hz, 1H), 6.29 (s, 1H), 3.49 (td, J=13.6, 8.3 Hz, 2H), 2.58 (s, 3H), 2.51 (t, J=7.1 Hz, 2H), 1.98 (p, J=7.2 Hz, 2H), 1.81 (h, J=8.3 Hz, 2H), 1.64 (s, 3H).

¹³C NMR (214 MHz, Methanol-d4) δ 172.25, 162.15, 147.10, 143.28, 139.97, 138.01, 134.93, 134.92, 134.58, 133.43, 133.39, 130.18, 130.12, 129.37, 129.11, 126.36, 123.10, 119.31, 118.65, 118.25, 115.62, 35.28, 26.03, 25.94, 21.67, 21.65, 21.33, 21.08, 14.05, 13.67.

LC-MS m/z, calculated for [M]+: 656.3. Found: 656.2.

### Example 4

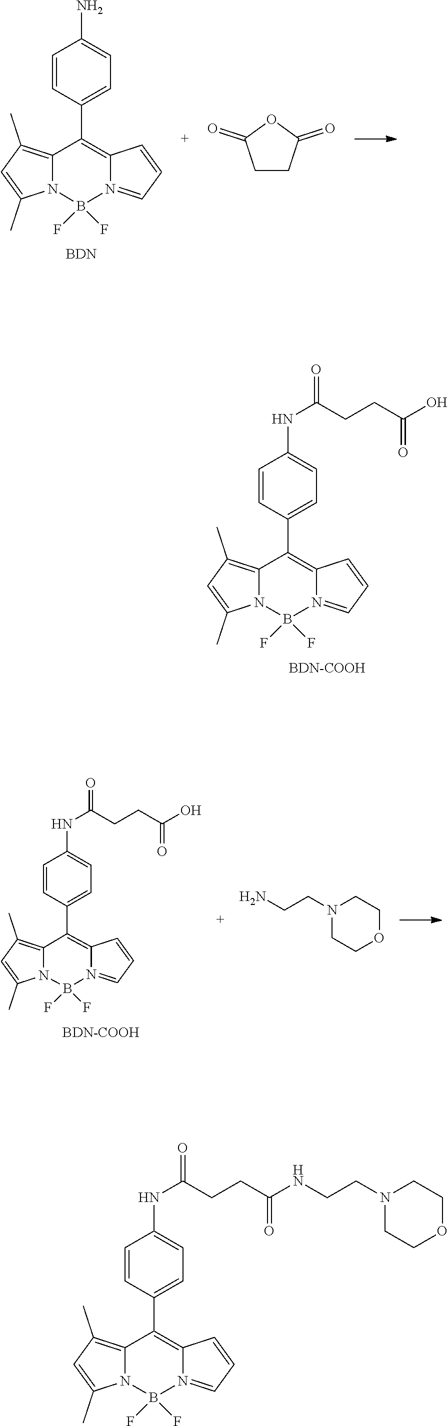

### Step 1: Preparation of BDN-C00H Compound

A BDN compound (100 mg, 321.4 μmol) was dissolved in 50 mL of acetonitrile (ACN), and anhydrous succinic acid (35.4 mg, 353.5 μmol) was added. The mixed solution was refluxed for 12 hours, concentration under vacuum was performed, and HPLC purification was performed to obtain a BDN-COOH compound (126.1 mg, 92.0%).

¹H NMR (850 MHz, Acetonitrile-d3) δ 8.68 (s, 1H), 7.76 (d, J=8.1 Hz, 2H), 7.65 (s, 1H), 7.37 (d, J=8.1 Hz, 2H), 6.49 (s, 1H), 6.43 (s, 1H), 6.30 (s, 1H), 2.67 (d, J=11.9 Hz, 4H), 2.58 (s, 3H), 1.63 (s, 3H).

¹³C NMR (214 MHz, Acetonitrile-d3) δ 173.62, 170.80, 162.50, 147.70, 143.60, 140.37, 137.83, 134.56, 133.62, 129.70, 128.44, 126.66, 123.56, 118.75, 116.00, 31.21, 28.43, 14.56, 14.33.

LC-MS m/z, calculated for [M+H]+: 412.2. Found: 412.2.

### Step 2: Preparation of Compound of Example 4

4-(2-aminoethyl)morpholine (4.8 μl, 36.5 μmol) was dissolved in 5 mL of DMF, and a solution of the BDN-COOH compound (10 mg, 24.3 μmol), HATU (9.2 mg, 24.3 μmol), and diethylisopropylamine (8.5 μl, 48.6 μmol) dissolved in 1 mL DMF was added. The reaction was carried out at room temperature for 12 hours, concentration under vacuum was carried out, and HPLC purification was performed to obtain the compound Example 4 (BODIPY compound 4) (7.4 mg, 58.0%).

¹H NMR (850 MHz, Chloroform-d) δ 8.63 (s, 1H), 8.16 (s, 1H), 7.69 (s, 1H), 7.66 (d, J=7.9 Hz, 2H), 7.32 (d, J=7.9 Hz, 2H), 6.42 (d, J=2.8 Hz, 1H), 6.40-6.36 (m, 1H), 6.15 (s, 1H), 4.02-3.98 (m, 4H), 3.78-3.73 (m, 2H), 3.71 (d, J=10.6 Hz, 2H), 3.34-3.28 (m, 2H), 2.94 (s, 2H), 2.84-2.78 (m, 2H), 2.72-2.67 (m, 2H), 2.64 (s, 3H), 1.60 (s, 3H).

¹³C NMR (214 MHz, Chloroform-d) δ 174.27, 171.09, 162.08, 161.57, 161.39, 146.87, 142.82, 139.08, 138.60, 134.70, 133.59, 129.72, 129.63, 126.85, 123.30, 119.68, 116.08, 63.59, 57.98, 53.03, 33.70, 32.62, 31.17, 15.25, 15.17.

LC-MS m/z, calculated for [M+H]+: 524.3. Found: 524.2.

### Example 5

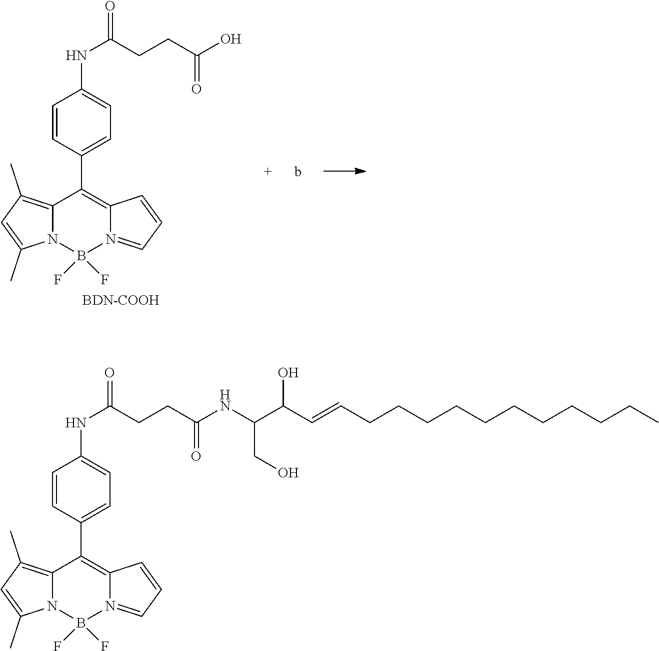

### (b): D-Sphingosine

D-sphingosine (7.3 mg, 24.3 μmol) was dissolved in 5 mL of DMF, and a solution of HATU (11.1 mg, 29.2 μmol) and diethylisopropylamine (10.2 μl, 58.4 μmol) dissolved in 1 mL of DMF was added. The reaction was carried out at room temperature for 12 hours, concentration under vacuum was carried out, and HPLC purification was performed to obtain the compound Example 5 (BODIPY compound 5) (10.6 mg, 63.0%).

¹H NMR (850 MHz, Chloroform-d) δ 7.74-7.67 (m, 3H), 7.31 (d, J=7.9 Hz, 2H), 6.42 (s, 1H), 6.38 (s, 1H), 6.14 (s, 1H), 5.87-5.79 (m, 1H), 5.55 (dd, J=15.3, 5.7 Hz, 1H), 4.40 (s, 1H), 4.03-3.98 (m, 1H), 3.98-3.93 (m, 1H), 3.77 (d, J=10.0 Hz, 1H), 2.85 (s, 2H), 2.75 (s, 2H), 2.64 (s, 3H), 2.07 (q, J=6.8 Hz, 2H), 1.60 (s, 3H), 1.41-1.36 (m, 2H), 1.33-1.25 (m, 22H), 0.90 (t, J=7.1 Hz, 3H).

¹³C NMR (214 MHz, Chloroform-d) δ 173.18, 171.23, 162.02, 146.81, 142.84, 139.13, 138.63, 134.70, 134.39, 133.57, 129.69, 128.30, 126.93, 123.26, 119.41, 116.07, 74.17, 61.81, 54.89, 32.84, 32.32, 31.93, 31.44, 29.70, 29.69, 29.66, 29.63, 29.50, 29.36, 29.25, 29.13, 22.69, 15.32, 15.16, 14.12.

LC-MS m/z, calculated for [M-F]+: 693.4. Found: 673.4.

### Example 6

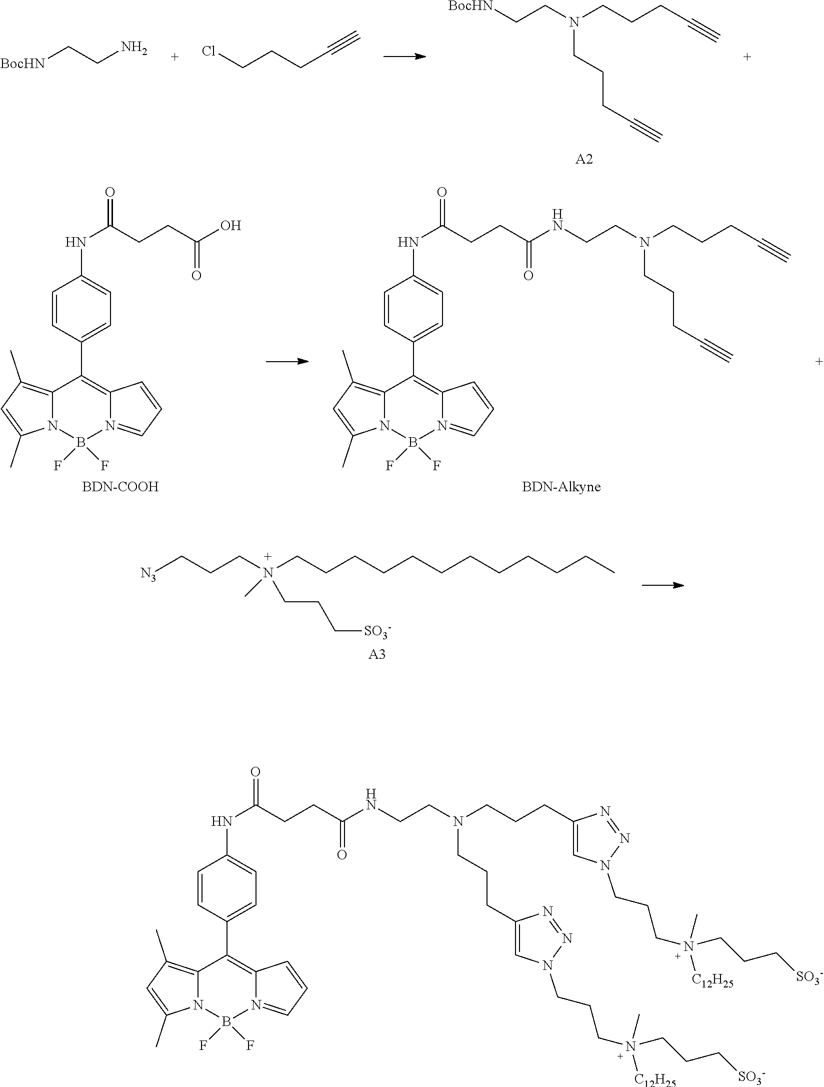

### Step 1: Preparation of Compound A2

N-Boc-ethylenediamine (100 μl, 632 μmol), 5-chloro-1-pentyne (133.9 μl, 1264 μmol), potassium carbonate (698.7 mg, 5056 μmol), and potassium iodide (419.6 mg, 2528 μmol) were dissolved in 12 mL of DMF. The solution was refluxed for 48 hours, the reaction solution was filtered, and concentration under vacuum was performed to obtain Compound A2.

¹H NMR (500 MHz, Chloroform-d) δ 4.97 (s, 1H), 3.12 (d, J=5.5 Hz, 2H), 2.46 (q, J=6.6 Hz, 6H), 2.19 (td, J=7.0, 2.6 Hz, 4H), 1.92 (t, J=2.6 Hz, 2H), 1.60 (p, J=6.9 Hz, 4H), 1.40 (s, 9H).

¹³C NMR (126 MHz, Chloroform-d) δ 156.00, 84.07, 78.88, 68.61, 53.46, 52.38, 38.34, 28.39, 25.88, 16.07.

LC-MS m/z, calculated for [M+H]+: 293.2. Found: 293.2

### Step 2: Preparation of BDN-Alkyne

Compound A2 (30.6 mg, 104.6 μmol) was dissolved in 20% TFA/DCM, and stirring was performed at room temperature for 2 hours. Thereafter, the reaction solution was concentrated under vacuum, the solution was dissolved in 5 mL of DMF again, and a solution of a BDN-COOH compound (21.5 mg, 52.3 μmol), HATU (19.9 mg, 52.3 μmol), and diethylisopropylamine (91.1 μl, 523 μmol) dissolved in 1 mL of DMF was added. The reaction was carried out at room temperature for 12 hours, concentration under vacuum was carried out, and then HPLC purification was performed to obtain a BDN-alkyne compound (15.7 mg, 51.2%).

¹H NMR (850 MHz, Chloroform-d) δ 8.58 (s, 1H), 8.03 (s, 1H), 7.69 (d, J=8.8 Hz, 3H), 7.31 (d, J=8.3 Hz, 2H), 6.43 (d, J=3.6 Hz, 1H), 6.38 (dd, J=3.8, 2.0 Hz, 1H), 6.15 (s, 1H), 3.70 (q, J=5.4 Hz, 2H), 3.39-3.32 (m, 4H), 3.30 (s, 2H), 2.83-2.79 (m, 2H), 2.70-2.66 (m, 2H), 2.63 (s, 3H), 2.36 (td, J=6.5, 2.5 Hz, 4H), 2.07 (t, J=2.6 Hz, 2H), 1.98 (s, 4H), 1.60 (s, 3H).

¹³C NMR (214 MHz, Chloroform-d) δ 174.98, 170.96, 162.09, 146.92, 142.90, 139.22, 138.55, 134.69, 133.60, 129.63, 129.56, 126.89, 123.32, 119.55, 116.06, 81.04, 71.00, 55.34, 52.98, 35.30, 32.59, 31.21, 22.11, 15.77, 15.32, 15.17.

### Step 3: Preparation of Compound of Example 6

Compound A3 was prepared according to the method described in Chem. Commun. 2015, 51, 17136-17139. CuSO₄·5H₂O (5 mg) and sodium ascorbate (5 mg) were dissolved in 300 μl of H₂O, and when the solution turned yellow, a solution of the BDN-alkyne compound (15.7 mg, 26.8 μmol) and Compound A3 (46.2 mg, 64.3 μmol) dissolved in 5 mL of DMF was added. The reaction was carried out at 60° C. for 12 hours, concentration under vacuum was carried out, and then HPLC purification was performed to obtain the compound Example 6 (BODIPY compound 6) (24.6 mg, 65.7%).

¹H NMR (850 MHz, Chloroform-d) δ 10.20 (s, 1H), 8.12 (s, 1H), 7.94 (s, 2H), 7.85 (s, 2H), 7.63 (s, 1H), 7.22 (s, 2H), 6.41-6.29 (m, 2H), 6.13 (s, 1H), 4.49 (s, 4H), 3.65 (s, 4H), 3.46 (d, J=54.2 Hz, 6H), 3.26 (s, 4H), 3.11 (s, 8H), 2.89 (d, J=64.9 Hz, 8H), 2.73 (d, J=50.5 Hz, 6H), 2.59 (s, 5H), 2.48 (s, 4H), 2.13 (d, J=20.4 Hz, 4H), 1.96 (s, 4H), 1.67 (s, 4H), 1.56 (s, 3H), 1.31-1.26 (m, 12H), 1.23 (d, J=12.3 Hz, 24H), 0.87 (t, J=7.2 Hz, 6H).

LC-MS m/z, calculated for [(M+2H)/2]+: 698.0. Found: 698.0.

### Example 7

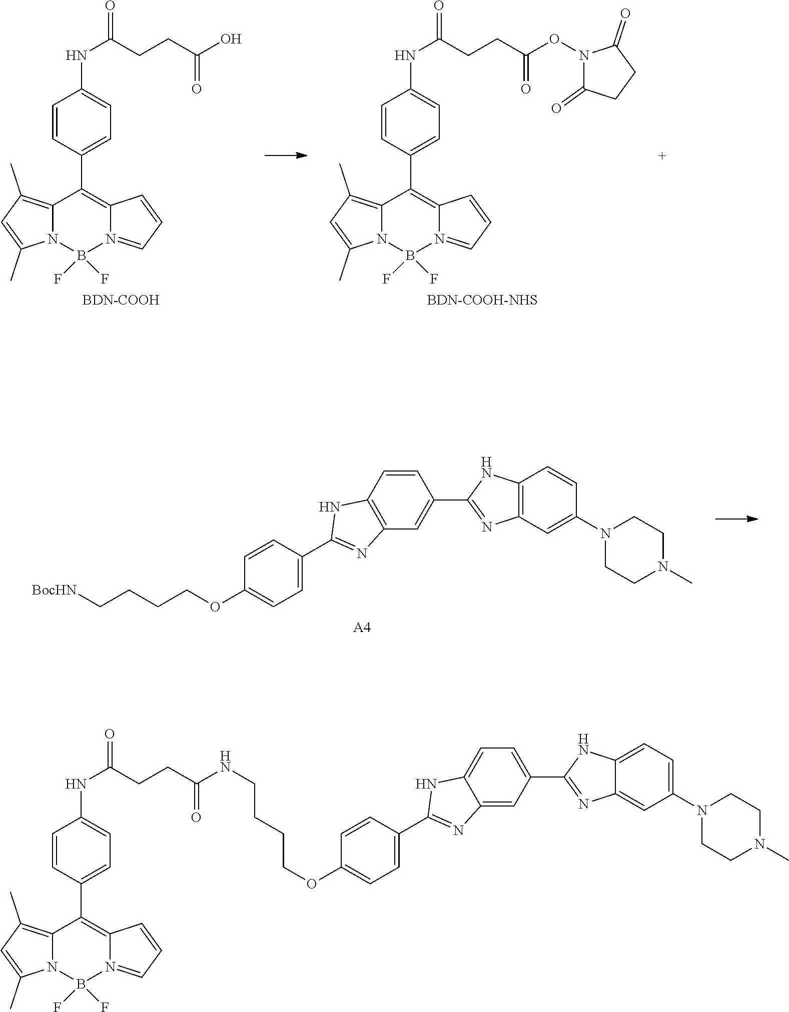

### Step 1: Preparation of BDN-COOH—NHS

A BDN-COOH compound (11.3 mg, 27.5 μmol), N-hydroxysuccinimide (4.7 mg, 41.2 μmol), and N-(3-dimethylaminopropyl)-N′-ethylcarbodiimide hydrochloride (7.9 mg, 41.2 μmol) were dissolved in 3 mL of DMF. The reaction was carried out at room temperature for 12 hours to obtain crude BDN-COOH—NHS.

### Step 2: Preparation of Compound of Example 7

Compound A4 was prepared according to the method described in Nat. Commun. 2015, 6, 8497. Compound A4 (18.3 mg, 30.7 μmol) was dissolved in a 20% trifluoroacetic acid (TFA)/DCM solution, and stirring was performed at room temperature for 2 hours. Thereafter, the reaction solution was concentrated under vacuum, the solution was dissolved in 1 mL of DMF again, and the crude BDN-COOH—NHS obtained above and diethylisopropylamine (47.9 μl, 275 μmol) were added. The reaction was carried out at room temperature for 12 hours, concentration under vacuum was carried out, and HPLC purification was performed to obtain the compound Example 7 (BODIPY compound 7) (10.6 mg, 43.3%).

¹H NMR (850 MHz, Methanol-d4) δ 8.33 (s, 1H), 8.26 (s, 1H), 8.07 (t, J=5.5 Hz, 1H), 8.03 (d, J=8.6 Hz, 2H), 7.98-7.94 (m, 1H), 7.73 (d, J=8.3 Hz, 2H), 7.70 (d, J=8.3 Hz, 1H), 7.58 (s, 1H), 7.55 (d, J=8.6 Hz, 1H), 7.26 (d, J=8.4 Hz, 2H), 7.24-7.19 (m, 1H), 7.10 (dd, J=8.7, 2.0 Hz, 1H), 7.07 (d, J=8.7 Hz, 2H), 6.40 (d, J=3.4 Hz, 1H), 6.36 (dd, J=3.5, 1.9 Hz, 1H), 6.13 (s, 1H), 4.06 (t, J=6.4 Hz, 2H), 3.44 (s, 4H), 3.37 (d, J=4.7 Hz, 4H), 3.30 (q, J=6.6 Hz, 2H), 2.91 (s, 3H), 2.74 (t, J=6.9 Hz, 2H), 2.60 (t, J=6.9 Hz, 2H), 2.47 (s, 3H), 1.89-1.83 (m, 2H), 1.76-1.70 (m, 2H), 1.54 (s, 3H).

¹³C NMR (214 MHz, Methanol-d4) δ 174.64, 173.12, 167.22, 163.35, 162.62, 155.43, 154.09, 148.41, 148.40, 139.23, 135.93, 134.73, 130.69, 130.20, 129.61, 127.76, 125.16, 124.38, 122.77, 120.60, 116.93, 116.73, 116.13, 103.40, 68.88, 55.23, 50.13, 44.01, 40.05, 33.10, 31.88, 27.57, 27.03, 15.42, 14.99.

LC-MS m/z, calculated for [M+H]+: 889.4. Found: 889.4.

The compounds of Examples 1 to 7 are summarized in the following Table 1:

TABLE 1

| No. | Chemical Formula | No. | Chemical Formula |
|---|---|---|---|
| 1 | 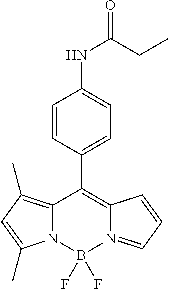 | 2 | 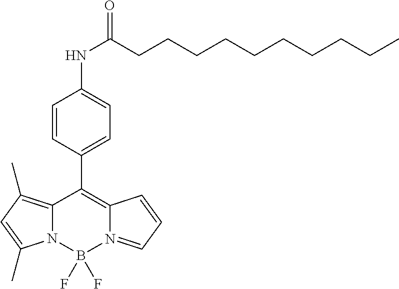 |
| 3 | 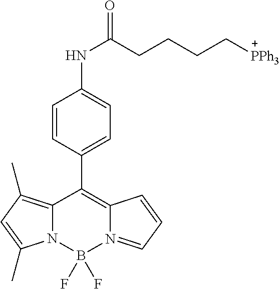 | 4 | 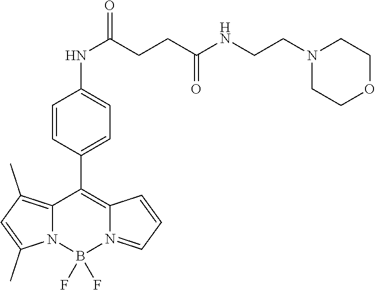 |

| | |
|---|---|
| 5 | 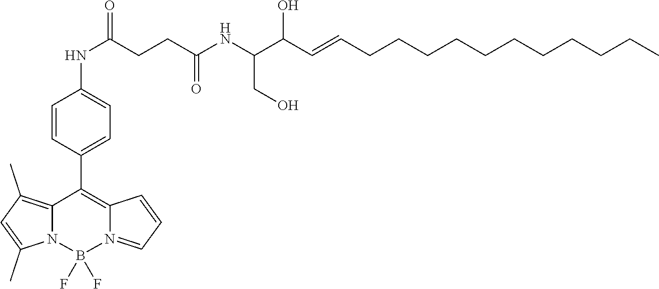 |
| 6 | 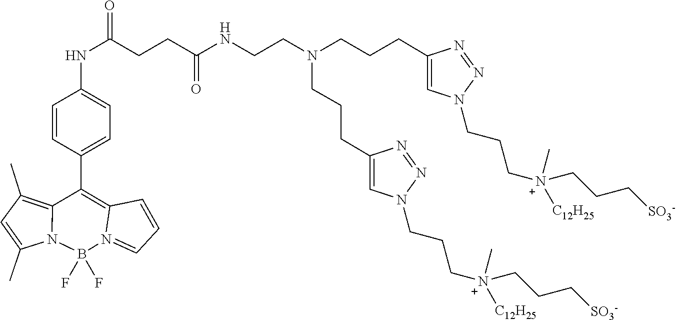 |
| 7 | 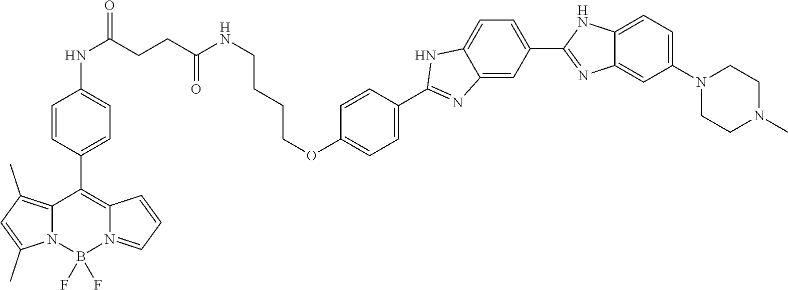 |

### Comparative Example 1

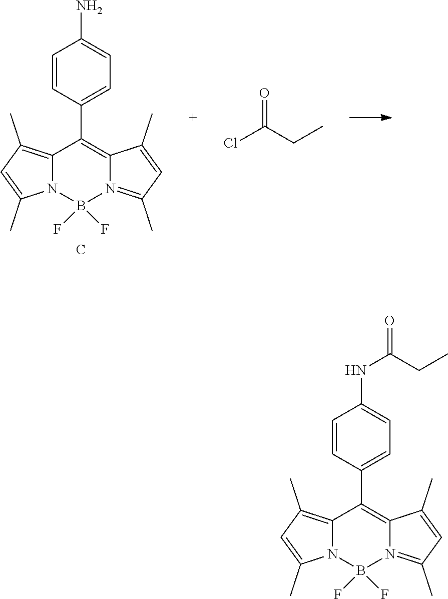

The compound of Comparative Example 1 was obtained in the same manner as in Example 1, except that Compound C was used instead of the BDN compound. Compound C was prepared by the method described in Spectrochim. Acta, Part A 2004, 60A, 987.

### Comparative Example 2

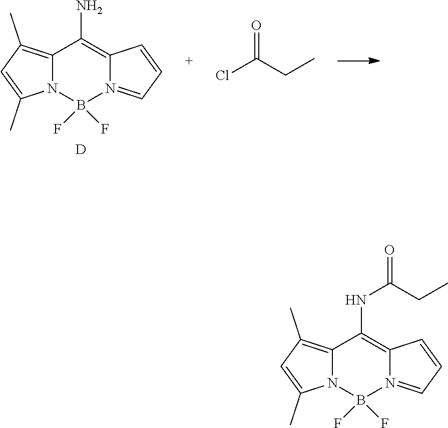

The compound of Comparative Example 2 was obtained in the same manner as in Comparative Example 1, except that Compound D was used instead of Compound C.

### Cell Culture

Each of HeLa cells and murine brown adipocytes was cultured in a Dulbecco's modified eagle's medium (hereinafter, referred to as DMEM) to which a fatal bovine serum (10%) and penicillin-streptomycin were added, and cultured on a 3.5 cm glass-based dish under the conditions of 37° C. and 5% CO₂.

### Evaluation Example

### Evaluation 1. Evaluation of Cell Organelle-Specificity

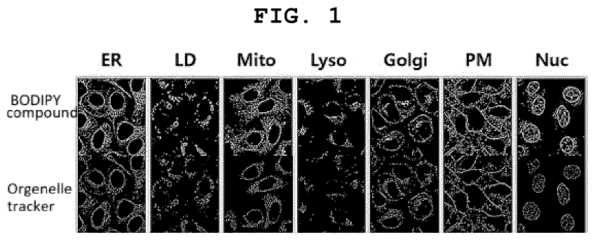

In order to confirm the cell organelle-specificity of the BODIPY compounds prepared in the examples, a co-localization test was carried out, and the results are shown in FIG. 1. The co-localization test was carried out by staining cells with the BODIPY compound of the example and a commercially available organelle tracker (endoplasmic reticulum: ER-Tracker™ Red, Golgi apparatus: BODIPY TR ceramide, nucleus: SYTOTM61 red fluorescent nucleic acid, mitochondria: MitoTracker Deep Red FM, plasma membrane: Cell Mask Orange, lysosome: LysoTracker Red DND-99, lipid droplet: Nile red). Specifically, the BODIPY compounds of Examples 1 and 3 to 7 and the organelle trackers corresponding thereto (endoplasmic reticulum, Golgi apparatus, nucleus, mitochondria, plasma membrane, and lysosome) were added to DMEM (HeLa cells) to be 800 nM and 500 nM, respectively, and culture was performed for 30 minutes under the conditions of 37° C. and 5% CO₂ to stain the cells. Thereafter, a confocal microscope (FV1200, Olympus) was used to compare and analyze the fluorescent image by the BODIPY compounds of the examples (emission wavelength: 490-540 nm, laser: 473 nm) and the fluorescent image by the organelle tracker (emission wavelength: 575-675 nm, laser: 561 nm). In addition, the co-localization test using the BODIPY compound of Example 2 and a lipid droplet tracker was performed identically using murine brown adipocytes.

Referring to FIG. 1, it was confirmed that the BODIPY compound of Example 1 may target endoplasmic reticulum (ER), the BODIPY compound of Example 2 may target lipid droplets (LD), the BODIPY compound of Example 3 may target mitochondria (Mito), the BODIPY compound of Example 4 may target lysosomes (Lyso), the BODIPY compound of Example 5 may target Golgi apparatuses (Golgi), the BODIPY compound of Example 6 may target plasma membranes (PM), and the BODIPY compound of Example 7 may target nuclei (Nuc).

### Evaluation 2. Evaluation of Temperature Sensitivity in Cells

A fluorescence lifetime imaging microscope (FLIM) was used to evaluate temperature sensitivity of the BODIPY compound prepared in the examples and the comparative example in cells.

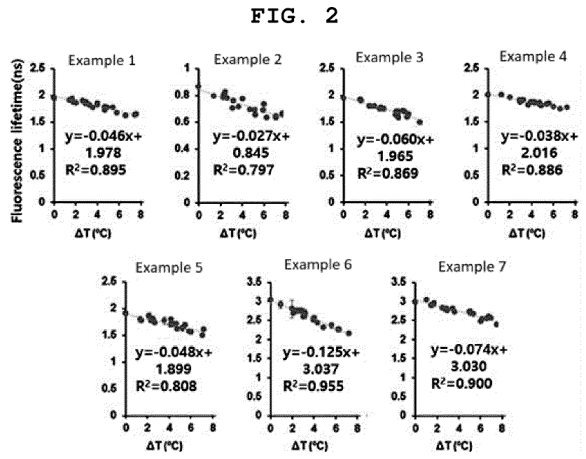

Specifically, each of the BODIPY compounds of the examples and the comparative examples was added to DMEM (Hela cells or murine brown adipocytes) to be a final concentration of 500 nM, and culture was performed for 30 minutes under the conditions of 37° C. and 5% CO₂ to stain the cells. Thereafter, graphite flake powder (98 mm, M199.95, NSC) which is a photothermal material was placed on the center of a glass dish, the graphite flakes were irradiated with 808 nm laser to derive a temperature rise of the stained cells. 808 nm laser (100 mW, laser core size: 50 mm, FiberLabs Inc.) was irradiated on the graphite flakes for 15 seconds and paused for 15 seconds, and the process was repeated three times. When the laser was irradiated for 15 seconds, local hot spots increased, and produced heat was transferred from graphite to surrounding cells to cause temperature gradient from a heating center (high temperature) to a surrounding area (low temperature). A FLIM image was captured every 1.66 seconds using a 485 nm pulse laser, all data of fluorescence lifetime was analyzed by SymPho Time 64 (PicoQuant), and fluorescence lifetime in each region of interest (ROI) during heating was analyzed. Graphs of fluorescence lifetime changes with increasing temperature (ΔT) of the BODIPY compounds of the examples and the comparative examples are shown in FIG. 2, and temperature sensitivities (ps/° C.) were calculated and are shown in the following Table 2.

As shown in FIG. 2, the BODIPY compounds of the examples had significantly decreased fluorescence lifetimes with increasing temperature, and it was found that the fluorescence lifetimes of the BODIPY compounds of the examples showed an inverse correlation with increasing temperature. In addition, it was confirmed that the ROI with a higher temperature showed a lower lifetime value than a region far from the graphite flakes. That is, the BODIPY compound according to the present invention is expected to be used to detect temperature gradients in cells in a micro scale.

TABLE 2

| | Example | | | | | | |
|---|---|---|---|---|---|---|---|
| | 1 | 2 | 3 | 4 | 5 | 6 | 7 |
| Temperature | 46 | 27 | 60 | 38 | 48 | 74 | 125 |
| sensitivity | | | | | | | |
| (ps/° C.) | | | | | | | |

In addition, as shown in Table 2, it was found that the BODIPY compound according to the present invention had very high temperature sensitivity. That is, the BODIPY compound according to an embodiment may visualize subtle temperature changes for each cell organelle and is expected to be useful as a temperature-sensitive fluorescent sensor of cell organelles. In addition, it was confirmed that the BODIPY compounds of Comparative Examples 1 and 2 had decreased temperature sensitivity as compared with the BODIPY compounds according to the examples. Specifically, though the compounds of Comparative Examples 1 and 2 may target ER like the compounds of Examples 1 and 2 of the present invention, since they have a BODIPY mother nucleus having a symmetric structure (Comparative Example 1) or do not include a phenylene linking group (Comparative Example 2), they were confirmed to have significantly decreased temperature sensitivity as compared with Example 1.

### Evaluation 3. Evaluation of Cytotoxicity

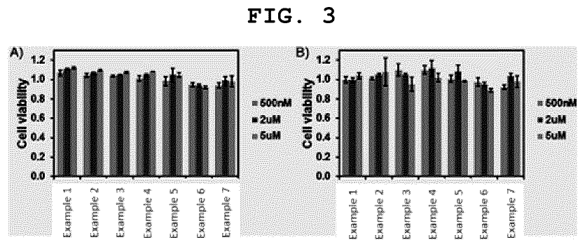

For evaluating cytotoxicity, a cell viability test was performed, and the results are shown in FIG. 3. Specifically, the BODIPY compounds of the examples in 96 well plate were added to HeLa cells at various concentrations (500 nM, 2 μM, 5 μM), and cultured in an incubator for 6 hours (A) of FIG. 3) and for 12 hours (B) of FIG. 3). 10 μl of a CCK-8 solution was added to each well, the plate was cultured for another hour, and an absorbance at 450 nm was measured using a SpectraMax M2e plate reader to analyze cell viability. Referring to FIG. 3, it was found that the BODIPY compound according to the present invention did not cause toxicity to cells.

1. A compound represented by the following Chemical Formula 1: 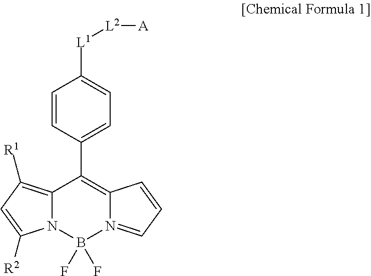
wherein
R¹ and R² are independently of each other (C1-C7)alkyl;
L¹ is —NR³C(═O)—, —C(═O)NR⁴—, or —NR⁵S(═O)₂—;
R³ to R⁵ are independently of one another hydrogen, (C1-C7)alkyl, or (C6-C12)aryl;
L² is a single bond, (C1-C30)alkylene, or (C1-C30)heteroalkylene;
—CH₂— of the alkylene and the heteroalkylene of L² may be replaced with one or two or more selected from —C(═O)— and —S(═O)₂—;
the alkylene and the heteroalkylene of L² may be further substituted by a hydroxyl group;
A is (C2-C30)alkyl, (C2-C30)alkenyl, (C6-C30)aryl, (C1-C7)alkyl(C6-C30)aryl, (C2-C30)heteroaryl, (C2-C30)heterocycloalkyl, 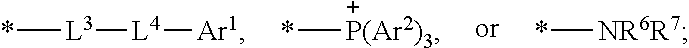
L³ and L⁴ are independently of each other (C2-C30)alkenylene, (C6-C30)arylene, or (C2-C30)heteroarylene;
Ar¹ is (C6-C30)aryl, (C1-C7)alkoxy(C6-C30)aryl, (C2-C30)heteroaryl, (C3-C30)cycloalkyl, or (C2-C30)heterocycloalkyl;
Ar² is (C6-C30)aryl or (C2-C30)heteroaryl;
R⁶ and R⁷ are independently of each other hydrogen, (C1-C20)alkyl, (C6-C20)aryl, or 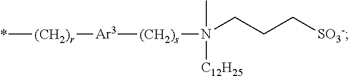
Ar³ is (C6-C30)arylene or (C2-C30)heteroarylene; and
r and s are independently of each other an integer of 1 to 5.

2. The compound of claim 1, wherein A is (C2-C20)alkyl, (C2-C20)alkenyl, (C1-C7)alkyl(C6-C20)aryl, (C2-C20)heterocycloalkyl, 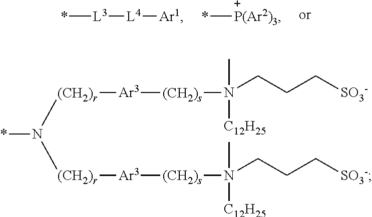
L³ is (C6-C20)arylene or (C2-C20)heteroarylene;
L⁴ is (C2-C20)alkenylene or (C2-C20)heteroarylene;
Ar¹ is (C1-C7)alkoxy(C6-C20)aryl or (C2-C20)heterocycloalkyl;
Ar² is (C6-C20)aryl;
Ar³ is (C2-C20)heteroarylene; and
r and s are independently of each other an integer of 1 to 5.

3. The compound of claim 1, wherein the compound is represented by any one of the following Chemical Formulae 2 to 7: 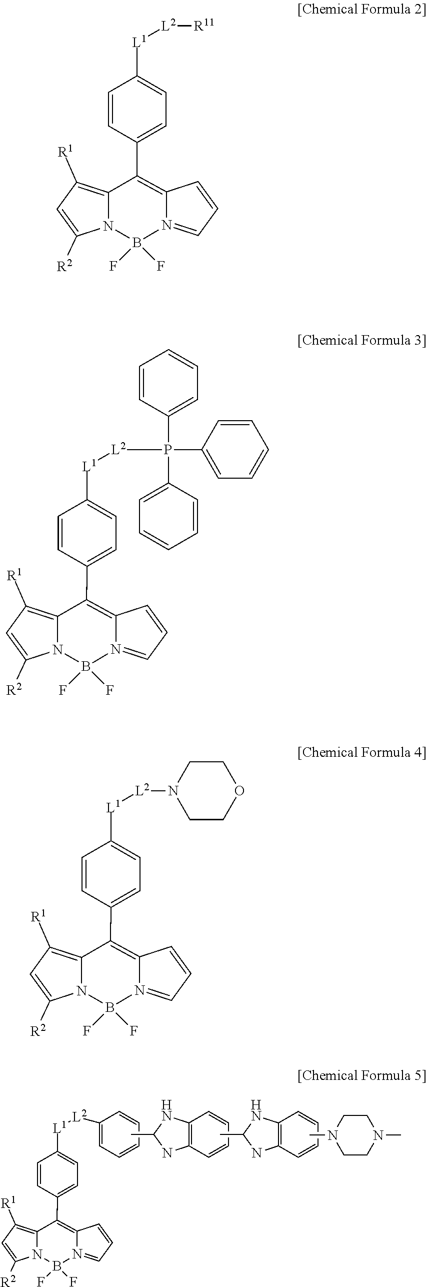 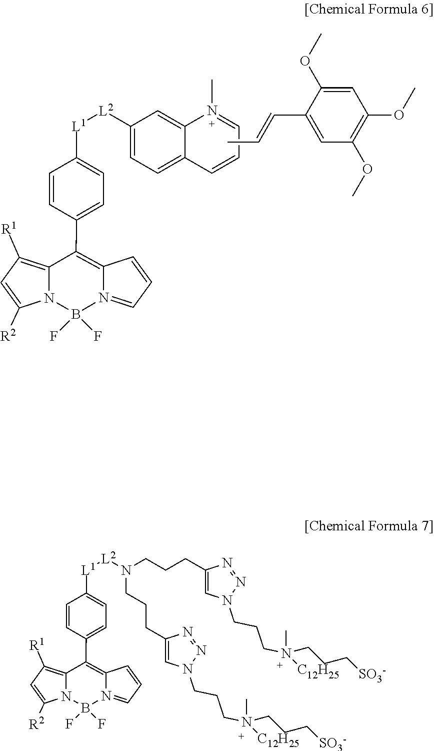
wherein
R¹ and R² are independently of each other (C1-C7)alkyl;
R¹¹ is (C2-C20)alkyl, (C2-C20)alkenyl, (C6-C20)aryl, or (C1-C7)alkyl(C6-C20)aryl;
L¹ is —NHC(═O)—, —C(═O)NH—, or —NHS(═O)₂—;
L² is a single bond, (C1-C20)alkylene, or (C1-C20)heteroalkylene;
—CH₂— of the alkylene and the heteroalkylene of L² may be replaced with one or two or more selected from —C(═O)— and —S(═O)₂—; and
the alkylene and the heteroalkylene of L² may be further substituted by a hydroxyl group.

4. The compound of claim 1,
wherein L² is a single bond, (C1-C10)alkylene, 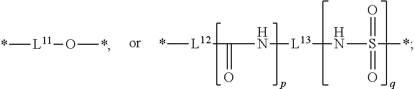
L¹¹ and L¹² are independently of each other (C1-C10)alkylene;
L¹³ is a single bond, (C1-C10)alkylene, or *-L¹⁴-O—*;
L¹⁴ is (C1-C10)alkylene;
the alkylene of L² and L¹¹ to L¹³ may be further substituted by a hydroxyl group; and
p and q are independently of each other an integer of 0 or 1, and at least one of p and q is 1.

5. The compound of claim 3, wherein the compound is represented by one of the following Chemical Formulae 11 to 18: 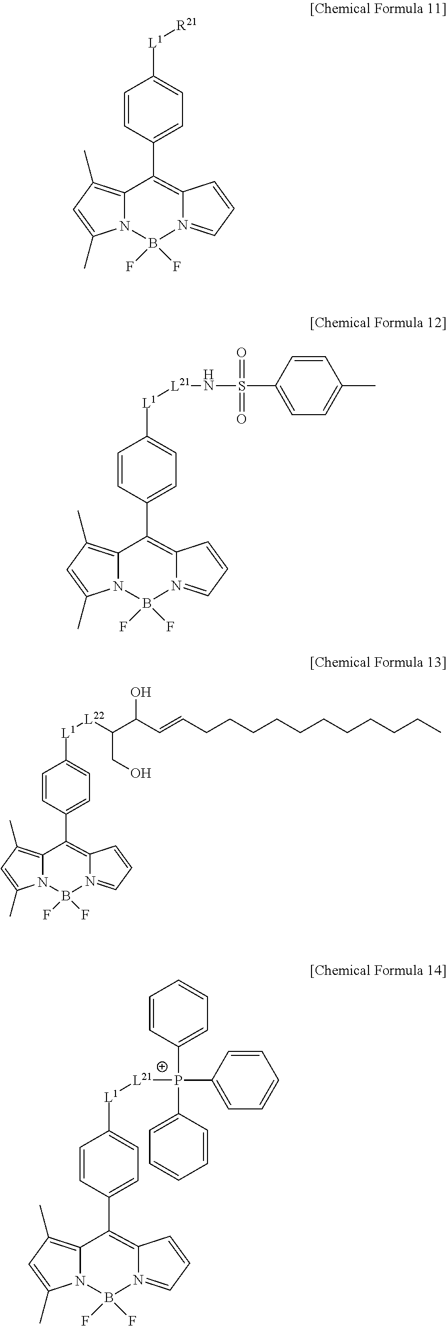 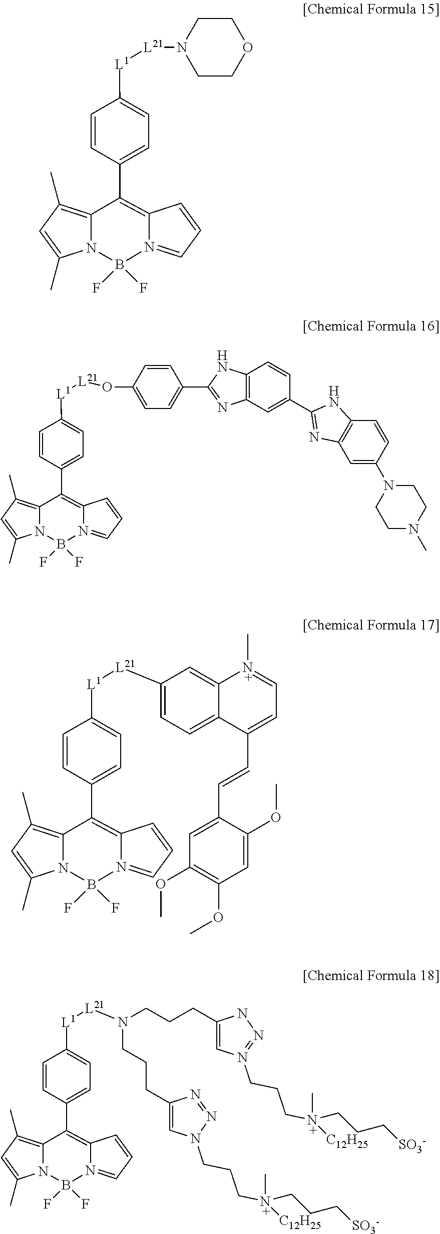
wherein
L¹ is —NHC(═O)—, —C(═O)NH—, or —NHS(═O)₂—;
R²¹ is (C2-C10)alkyl or 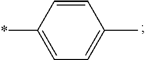 [SMILES: *c1ccc(C)cc1]
L²¹ is (C1-C4)alkylene or 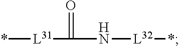
L²² is a single bond or 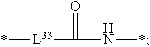
and
L³¹ to L³³ are independently of one another (C1-C4)alkylene.

6. The compound of claim 1, wherein the compound is selected from the following structures:

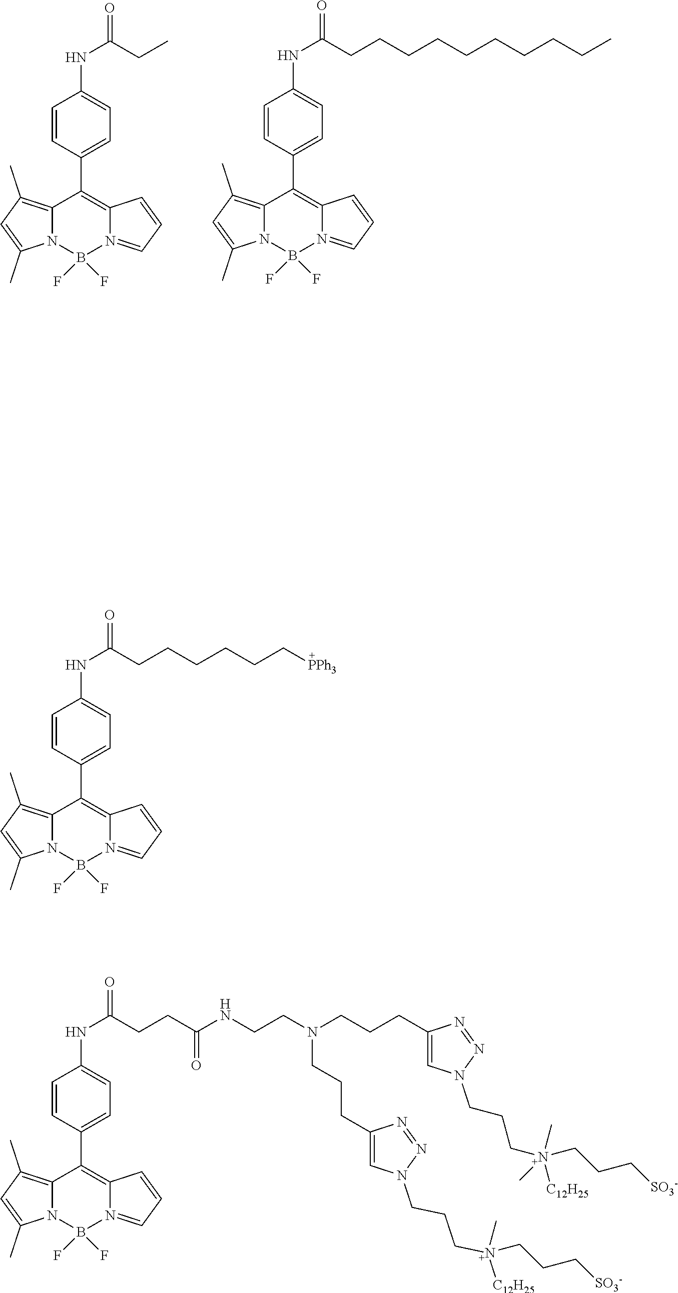

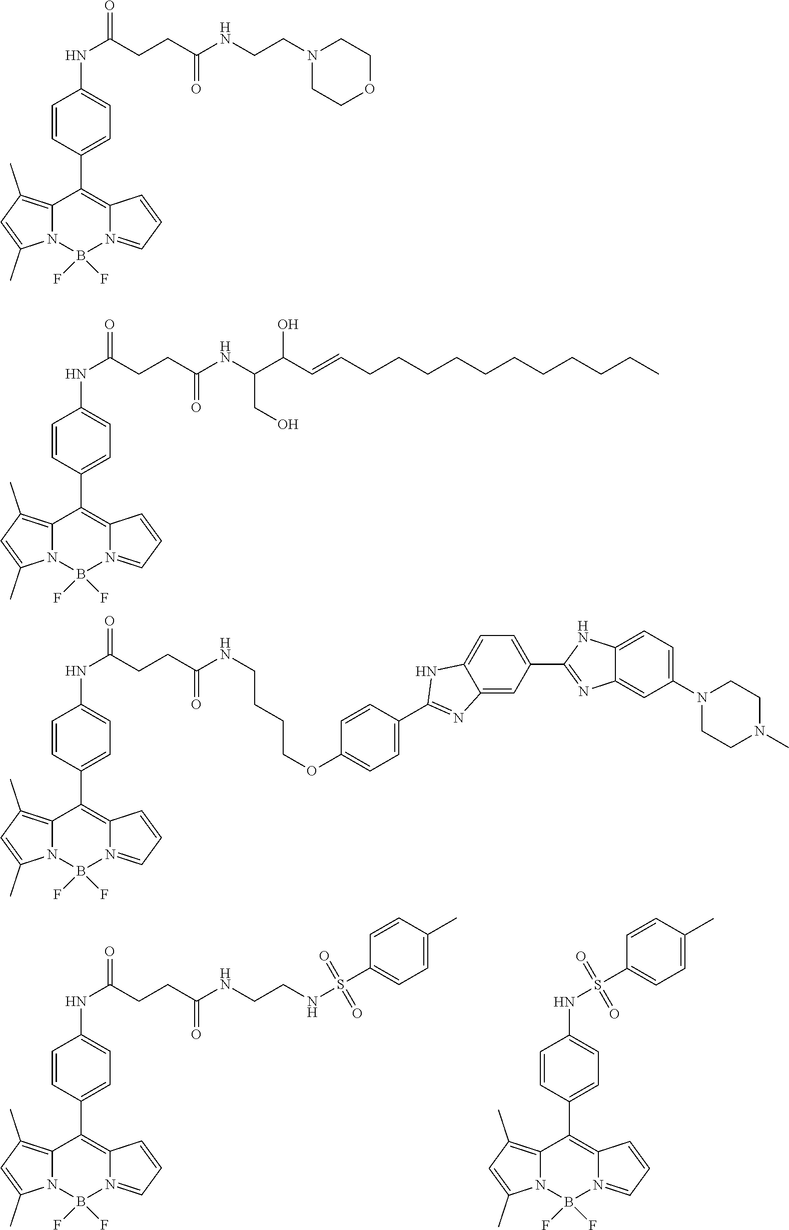

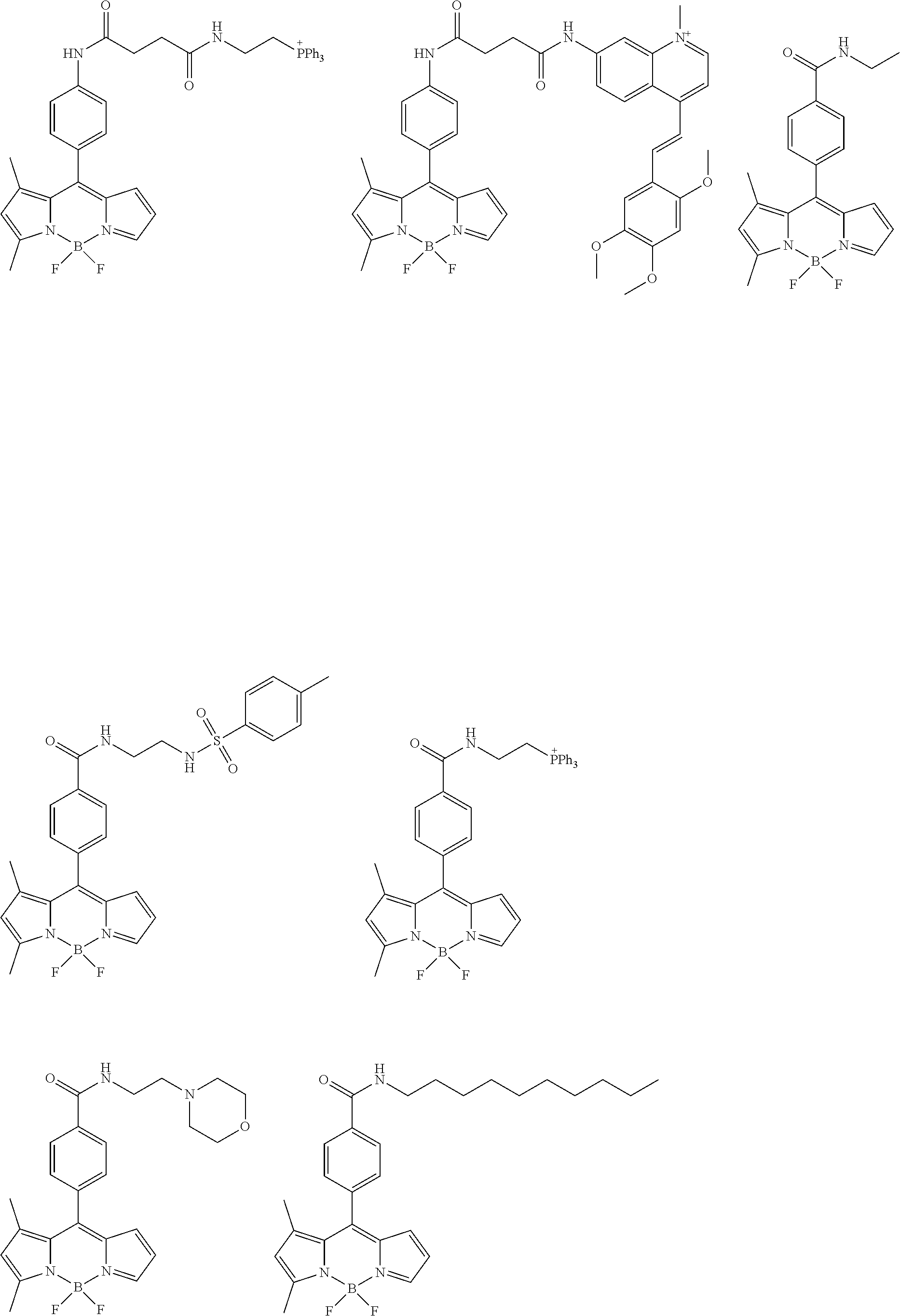

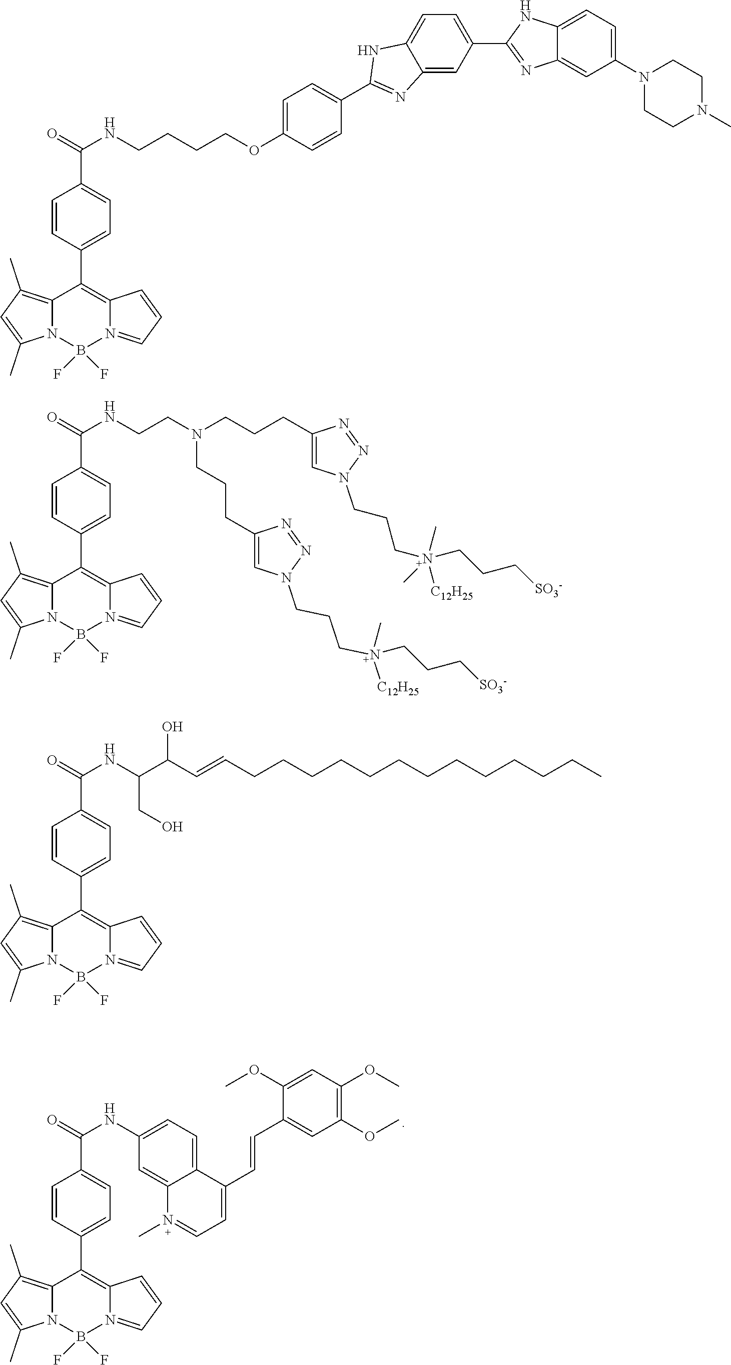

7. The compound of claim 3, wherein the compound targets different organelles from each other.

8. The compound of claim 7, wherein the compound targets cell organelles including endoplasmic reticulum, lipid droplets, Golgi apparatuses, mitochondria, lysosomes, nuclei, nucleoli, and plasma membranes.

9. A temperature-sensitive fluorescent sensor of cell organelles, comprising a compound represented by the following Chemical Formula 1: 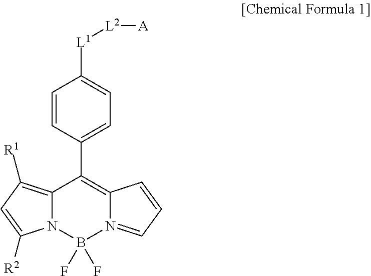
wherein
R₁, R₂, L₁, L₂, and A are as defined in Chemical Formula 1 of claim 1.

10. The temperature-sensitive fluorescent sensor of cell organelles of claim 9, wherein the cell organelle includes endoplasmic reticulum, lipid droplets, Golgi apparatuses, mitochondria, lysosomes, nuclei, nucleoli, and plasma membranes.

11. A method for measuring temperature of cell organelles, using the fluorescent sensor of claim 9.

12. The method for measuring temperature of cell organelles of claim 11, wherein the method includes:
bringing the fluorescent sensor into contact with cells to stain the cells;
analyzing a fluorescence lifetime of the stained cell; and
calculating the temperature of the cell organelles depending on the analyzed fluorescence lifetime.
